(19) United States
(12) Patent Application Publication
(10) Pub. No.: US 2009/0079345 A1
(43) Pub. Date: Mar. 26, 2009

(54) LIGHT EMITTING/RECEIVING ELEMENT

(75) Inventor: Masafumi INUIYA, Ashigarakami-gun (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/238,527

(22) Filed: Sep. 26, 2008

(30) Foreign Application Priority Data
Sep. 26, 2007 (JP) 2007-249917
Sep. 26, 2007 (JP) 2007-249918
Sep. 26, 2007 (JP) 2007-249919

(51) Int. Cl. H01J 40/00

(52) U.S. Cl. 313/523

(57) ABSTRACT

A light emitting/receiving element includes: a substrate; an organic layer which is provided above the substrate; a forward bias power supply which applies a bias voltage between both ends of the organic layer so as to inject charges from an outside into the organic layer; a reverse bias power supply which applies a bias voltage, which is opposite in polarity to the bias voltage applied by the forward bias power supply, between the both ends of the organic layer so as to extract charges generated in the organic layer to the outside; and a current detecting unit, wherein the organic layer includes an organic material which, when the bias voltage is applied by the forward bias power supply, has the light emitting function, and which, when the bias voltage is applied by the reverse bias power supply, has the photoelectric converting function.

### CROSS-REFERENCE TO RELATED APPLICATIONS

This application claims the benefit of Japanese Patent Application JP 2007-249917, filed Sep. 26, 2007, Japanese Patent Application JP 2007-249918, filed Sep. 26, 2007, and Japanese Patent Application JP 2007-249919, filed Sep. 26, 2007, the entire contents of which are hereby incorporated by reference, the same as if set forth at length.

### FIELD OF THE INVENTION

The present invention relates to a light emitting/receiving element having a light emitting function, and a photoelectric converting function of converting received light to charges, and also to an imaging apparatus having a photoelectric converting function of converting light from an object to charges, and an illuminating function of illuminating the object.

### BACKGROUND OF THE INVENTION

Conventionally, an imaging apparatus in which light emitting elements and light receiving elements are mixedly used has been proposed (see JP-A-2007-104088 (corresponding to US2007/0077105A1)). In the imaging apparatus, light emitted from the light emitting elements is incident on an object, and reflected thereby to be received by the light receiving elements, whereby imaging of the object is enabled. Each of the light receiving elements is configured by a photoelectric converting layer and a pair of electrodes sandwiching the layer, and each of the light receiving elements is configured by a light emitting layer and a pair of electrodes sandwiching the layer. The photoelectric converting layer and the light emitting layer are formed completely independently from each other.

### SUMMARY OF THE INVENTION

In the imaging apparatus disclosed in JP-A-2007-104088 (corresponding to US2007/0077105A1), the light emitting elements and light receiving elements which have different configurations must be formed in a large number on the same face. Therefore, film formation and patterning of the light emitting layers, and those of the photoelectric converting layers must be separately conducted, with the result that the apparatus cannot be easily produced.

The invention has been conducted under the above-discussed circumstances. It is an object of the invention to provide a light emitting/receiving element and imaging device which have both the function of a light receiving element and that of a light emitting element, and which can be easily produced.

The light emitting/receiving element of a first aspect of the invention is a light emitting/receiving element having a light emitting function, and a photoelectric converting function of converting received light to charges, wherein the element includes: an organic layer which is formed above a substrate; a forward bias power supply which, in order to inject charges from an outside into the organic layer, applies a bias voltage (hereinafter, referred to as forward bias) between both ends of the organic layer; a reverse bias power supply which, in order to extract (collect) charges generated in the organic layer to the outside, applies a bias voltage (hereinafter, referred to as reverse bias) which is opposite in polarity to the forward bias, between the both ends of the organic layer; and a current detecting unit which detects a current corresponding to charges generated in the organic layer when the reverse bias is applied, and the organic layer is made of an organic material which, when the forward bias is applied, has the light emitting function, and which, when the reverse bias is applied, has the photoelectric converting function.

In the light emitting/receiving element of the first aspect of the invention, the element further includes: a first electrode which is formed between the substrate and the organic layer; a second electrode which is formed at a position opposed to the first electrode across the organic layer; and a switching unit which is switchable between a state where the forward bias power supply is connected between the first and second electrodes, and a state where the reverse bias power supply is connected between the first and second electrodes.

In the light emitting/receiving element of the first aspect of the invention, one of the first and second electrodes is a transparent electrode.

In the light emitting/receiving element of the first aspect of the invention, the first electrode, the organic layer, and the second electrode are two-dimensionally arranged in a large number.

In the light emitting/receiving element of the first aspect of the invention, either of the large number of first electrodes and the large number of second electrodes are configured as a single commoned electrode, and the large number of organic layers are configured as a single commoned layer.

In the light emitting/receiving element of the first aspect of the invention, the element further includes: first and second electrodes which are formed while being juxtaposed in parallel to the substrate, between the substrate and the organic layer; and a common electrode which is formed at a position opposed to the second and first electrodes across the organic layer, and which is common to the first and second electrodes, the forward bias power supply is connected between the first electrode and the common electrode, the reverse bias power supply is connected between the second electrode and the common electrode, and the current detecting unit detects a current which flows between the second electrode and the reverse bias power supply, or between the common electrode and the reverse bias power supply.

In the light emitting/receiving element of the first aspect of the invention, the common electrode and one of the first and second electrodes are transparent electrodes.

In the light emitting/receiving element of the first aspect of the invention, the first electrode and the second electrode are two-dimensionally arranged in a large number.

In the light emitting/receiving element of the first aspect of the invention, the forward bias power supply is a voltage variable power supply which can change a supply voltage.

According to the first aspect of the invention, it is possible to provide a light emitting/receiving element which has both the function of a light receiving element and that of a light emitting element, and which can be easily produced.

The imaging apparatus of a second aspect of the invention is an imaging apparatus having a photoelectric converting function of converting light from an object to charges, and an illuminating function of illuminating the object, wherein the apparatus includes: light receiving elements and light emitting elements which are arranged above a substrate, each of the light receiving elements including an organic layer which is formed above the substrate, and a pair of electrodes which sandwich the organic layer, each of the light emitting elements including an organic layer which is formed above the substrate, and a pair of electrodes which sandwich the organic layer; a forward bias power supply which is connected between the pair of electrodes of each of the light emitting elements, and which, in order to inject charges into the organic layer of the light emitting element, applies a bias voltage (hereinafter, referred to as forward bias) between the pair of electrodes; a reverse bias power supply which is connected between the pair of electrodes of each of the light receiving elements, and which, in order to extract charges generated in the organic layer of the light receiving element to an outside, applies a bias voltage (hereinafter, referred to as reverse bias) which is opposite in polarity to the forward bias, between the pair of electrodes; and a current detecting unit which detects a signal current corresponding to charges generated in the organic layer of the light receiving element when the reverse bias is applied, in the pairs of electrodes included in the light receiving element and the light emitting element, electrodes which are closer to the object are transparent electrodes, and the organic layer of the light receiving element and the organic layer of the light emitting element are layers which, when the forward bias is applied, have a light emitting function, which, when the reverse bias is applied, have the photoelectric converting function, and in which an emission wavelength in the application of the forward bias overlaps with a reception wavelength in the application of the reverse bias, and made of a same material.

In the imaging apparatus of the second aspect of the invention, the organic layer has a two-layer structure of first and second organic layers which are sequentially placed with starting from a side of an electrode that is one of the pair of electrodes, and that is remoter from the object, an emission wavelength range of the second organic layer in the application of the forward bias overlaps with an emission wavelength range of the first organic layer in the application of the reverse bias, and the emission wavelength range of the first organic layer in the application of the reverse bias overlaps with a transmission wavelength range of the second organic layer in the application of the reverse bias.

In the imaging apparatus of the second aspect of the invention, the first organic layer is made of quinacridone, and the second organic layer is made of Alq3 (tris (8-hydroxyquinoline) aluminum).

In the imaging apparatus of the second aspect of the invention, the apparatus further includes: a first functional layer which is formed between one of the pair of electrodes and the organic layer, which, in the application of the forward bias, functions as a hole transporting layer that transports holes injected from the one electrode to the organic layer, and which, in the application of the reverse bias, functions as an electron blocking layer that blocks electrons from the one electrode from being moved to the organic layer; and a second functional layer which is formed between another one of the pair of electrodes and the organic layer, which, in the application of the forward bias, functions as an electron transporting layer that transports electrons injected from the other electrode to the organic layer, and which, in the application of the reverse bias, functions as a hole blocking layer that blocks holes from the other electrode from being moved to the organic layer.

In the imaging apparatus of the second aspect of the invention, the apparatus further includes: a first functional layer which is formed between one of the pair of electrodes that is closer to the object, and the second organic layer, which, in the application of the forward bias, functions as an electron transporting layer that transports electrons injected from the one electrode to the organic layer, and which, in the application of the reverse bias, functions as a hole blocking layer that blocks holes from the one electrode from being moved to the organic layer; and a second functional layer which is formed between another one of the pair of electrodes that is remoter from the object, and the first organic layer, which, in the application of the forward bias, functions as a hole transporting layer that transports holes injected from the other electrode to the organic layer, and which, in the application of the reverse bias, functions as an electron blocking layer that blocks electrons from the other electrode from being moved to the organic layer, and the second organic layer is used also as the first functional layer.

In the imaging apparatus of the second aspect of the invention, an electrode which is one of the pair of electrodes of the light emitting element, and which is remoter from the object is transparent, an electrode which is one of the pair of electrodes of the light receiving element, and which is remoter from the object is opaque, and the apparatus further includes a lighting controlling unit which, after an exposure period of the light receiving element is ended, applies a forward bias according to a signal corresponding to charges that are generated in the organic layer during the exposure period, between the pair of electrodes of the light emitting element adjacent to the light receiving element.

In the imaging apparatus of the second aspect of the invention, the light receiving element and the light emitting element are two-dimensionally arranged in a large number.

In the imaging apparatus of the second aspect of the invention, the organic layer of the light receiving element and the organic layer of the light emitting element are configured as a single commoned layer, and an electrode which is one of the pair of electrodes of the light emitting element, and which is closer to the object, and an electrode which is one of the pair of electrodes of the light receiving element, and which is closer to the object are configured as a single commoned electrode.

According to the second aspect of the invention, it is possible to provide an imaging apparatus which has both the function of a light receiving element and that of a light emitting element, and which can be easily produced.

The imaging device of a third aspect of the invention is an imaging device including: a plurality of photoelectric converting elements which are arranged above a substrate; and a light emitting element which is formed above the plurality of photoelectric converting elements, and which includes a light emitting layer in which an emission wavelength range is different from an absorption wavelength range.

In the imaging device of the third aspect of the invention, the light emitting element includes: a first transparent electrode which is disposed between the plurality of photoelectric converting elements and the light emitting layer; and a second transparent electrode which is opposed to the first transparent electrode across the light emitting layer, and the first and second transparent electrodes are electrodes which allow at least light of the emission wavelength range of the light emitting layer to pass through the electrodes.

In the imaging device of the third aspect of the invention, each of the photoelectric converting elements includes: a first electrode which is formed above the substrate; a second electrode which is formed above the first electrode, and which allows at least light of the emission wavelength range of the light emitting element to pass through the electrode; and a photoelectric converting layer which is formed between the first and second electrodes, and an absorption wavelength range of the photoelectric converting layer overlaps with the emission wavelength range of the light emitting layer.

In the imaging device of the third aspect of the invention, the photoelectric converting layer and the light emitting layer are made of an organic material.

In the imaging device of the third aspect of the invention, the photoelectric converting layer is made of quinacridone, and the light emitting layer is made of Alq3 (tris (8-hydroxyquinoline) aluminum).

In the imaging device of the third aspect of the invention, the second electrode and the photoelectric converting layer are configured as a single-layer structure which is common to the plurality of photoelectric converting elements.

In the imaging device of the third aspect of the invention, the second electrode functions also as the first transparent electrode which is disposed between the photoelectric converting element and the light emitting layer.

In the imaging device of the third aspect of the invention, the photoelectric converting elements are two-dimensionally arranged above the substrate.

In the imaging device of the third aspect of the invention, the device further includes a member which is disposed above the light emitting element and at a position where the member overlaps with a part of the plurality of photoelectric converting elements, and which has a light blocking function of preventing light reflected from the object from being incident on the part of the photoelectric converting elements, and an absorbing function of absorbing light that is emitted toward a side opposite to a side of the photoelectric converting elements among the light emitted from the light emitting layer.

The imaging apparatus of the third aspect of the invention includes; the imaging device; and a signal processing unit for performing a signal process of removing a signal which is included in a signal obtained from photoelectric converting elements other than the part of photoelectric converting elements in accordance with light reflected from the object, and which correspond to light emitted from the light emitting layer toward the side of the photoelectric converting elements, by using a signal obtained from the part of photoelectric converting elements.

According to the third aspect of the invention, it is possible to provide an imaging device which has both the function of a light receiving element and that of a light emitting element, and which can be easily produced.

### BRIEF DESCRIPTION OF THE DRAWINGS

FIG. 1 is a sectional diagram schematically showing the configuration of a light emitting/receiving element of an embodiment of a first aspect of the invention.

FIG. 2 is a sectional diagram showing another configuration example of the light emitting/receiving element of the embodiment of the first aspect of the invention.

FIG. 3 is a partial sectional diagram schematically showing the configuration of a two-dimensional scanner which is an imaging apparatus of an embodiment of a second aspect of the invention.

FIG. 4 is a view showing emission and absorption characteristics of quinacridone.

FIG. 5 is a view showing emission and absorption characteristics of Alq3.

FIG. 6 is a diagram showing a modification of the configuration of the two-dimensional scanner shown in FIG. 3.

FIG. 7 is a view showing the whole configuration of the two-dimensional scanner of the embodiment.

FIG. 8 is a diagram schematically showing the configuration of a driving circuit of the two-dimensional scanner of the embodiment.

FIG. 9 is an enlarged view of a light emitting/receiving unit shown in FIG. 8.

FIG. 10 is a chart showing the operation timing of the two-dimensional scanner in the case where a scan result is to be displayed on a displaying unit.

FIG. 11 is a view showing a state of the displaying unit during the operation of the two-dimensional scanner in the case where the scan result is to be displayed on the displaying unit.

FIG. 12 is a timing chart in the case where an image other than the scan result is to be displayed on the displaying unit.

FIG. 13 is a diagram showing a relationship between a touch pen and the driving circuit.

FIG. 14 is a timing chart for calculating the horizontal and vertical coordinates of the touch pen.

FIG. 15 is a partial sectional diagram schematically showing the configuration of an imaging device of a first embodiment of a third aspect of the invention.

FIG. 16 is a view showing an arrangement example of an absorbing member.

FIG. 17 is a diagram showing an example of a clamp circuit which is mounted in the imaging apparatus of the embodiment, and which is a circuit for removing a background signal.

FIGS. 18A, 18B and 18C are views illustrating the operation of the clamp circuit shown in FIG. 17.

FIG. 19 is a partial sectional diagram schematically showing the configuration of an imaging device of a second embodiment of the third aspect of the invention.

FIG. 20 is a partial sectional diagram schematically showing the configuration of an imaging device of a third embodiment of the third aspect of the invention.

### DETAILED DESCRIPTION OF THE INVENTION

Hereinafter, embodiments of a first aspect of the invention will be described with reference to the drawings.

### First Embodiment

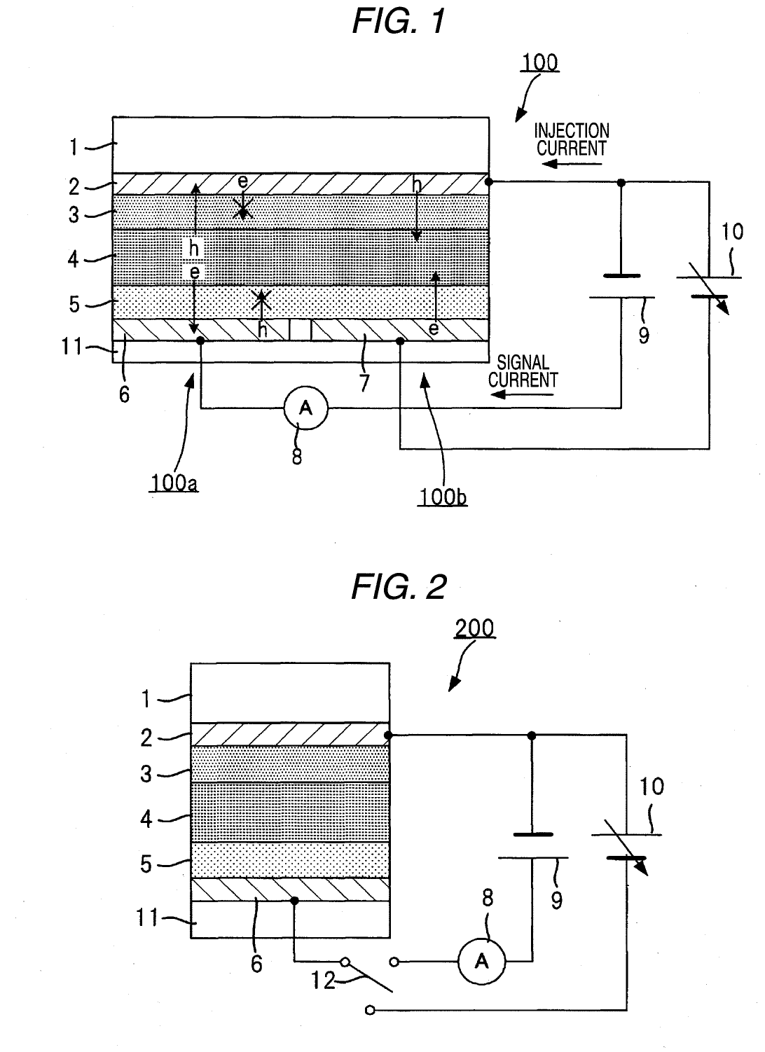

FIG. 1 is a sectional diagram schematically showing the configuration of a light emitting/receiving element of an embodiment of the invention.

The light emitting/receiving element 100 includes: a light receiving element 100a having a photoelectric converting function of receiving light and generating charges in accordance with received light; and a light emitting element 100b having a light emitting function of emitting light, and has a configuration where these elements are two-dimensionally alternately arranged above a substrate 11.

Each of the light receiving element 100a and the light emitting element 100b has a basic configuration which is configured by an organic layer and a pair of electrodes sandwiching the organic layer. In the light emitting/receiving element 100, the organic layer constituting the light receiving element 100a, and that constituting the light emitting element 100b are made of the same material, and bias voltages which are applied respectively to the organic layers are differentiated from each other, thereby enabling the organic layer of the light receiving element 100a to function as a photoelectric converting layer, and that of the light emitting element 100b to function as a light emitting layer.

The light emitting/receiving element 100 includes: the substrate 11; a light receiving electrode 6 which is formed on the substrate 11 and at a position where the light receiving element 100a is to be formed, and which is an electrode for the light receiving element 100a; a light emitting electrode 7 which is formed on the substrate 11 and at a position where the light emitting element 100b is to be formed, and which is an electrode for the light emitting element 100b; a functional layer 5 which is formed on the light receiving electrode 6 and the light emitting electrode 7, and which has a hole blocking function and an electron transporting function; an organic layer 4 which is formed on the functional layer 5; a functional layer 3 which is formed on the organic layer 4, and which has an electron blocking function and a hole transporting function; a common electrode 2 which is formed on the functional layer 3, and which has a single-layer structure that is common to the light receiving element 100a and the light emitting element 100b; a sealing substrate 1 which is used for protecting elements formed on the common electrode 2, and which is transparent to visible light; a reverse bias power supply 9 which is connected between the light receiving electrode 6 and the common electrode 2; a forward bias power supply 10 which is connected between the light emitting electrode 7 and the common electrode 2; and an ammeter 8 which is connected between the light receiving electrode 6 and the reverse bias power supply 9, and which is a current detecting unit.

Each of the functional layer 3, the organic layer 4, and the functional layer 5 is formed as a single layer which is common to the light receiving element 100a and the light emitting element 10b. The common electrode 2 is made of a material (for example, ITO) which is transparent to visible light so that light generated in the organic layer 4 can upward pass through the electrode, and light incident from the upper side can enter the organic layer 4.

The forward bias power supply 10 is used for applying a bias voltage for injecting charges (holes and electrons) from the light emitting electrode 7 and the common electrode 2 into the organic layer 4 interposed between the light emitting electrode 7 and the common electrode 2 (hereinafter, such a bias voltage is referred to as forward bias), to the light emitting electrode 7 and the common electrode 2. The forward bias power supply 10 can be changed by a switch (not shown) between a state where the forward bias is applied to the light emitting electrode 7 and the common electrode 2, and that where the forward bias is not applied to the electrodes. The forward bias power supply 10 is formed as a voltage variable power supply which can change the level of the voltage to be applied.

The reverse bias power supply 9 is used for applying a bias voltage which moves charges generated in the organic layer 4 interposed between the light receiving electrode 6 and the common electrode 2, to the light receiving electrode 6 and the common electrode 2, and which is opposite in polarity to the forward bias (hereinafter, such a bias voltage is referred to as reverse bias), to the light receiving electrode 6 and the common electrode 2. The reverse bias power supply 9 can be changed by a switch (not shown) between a state where the reverse bias is applied to the light receiving electrode 6 and the common electrode 2, and that where the reverse bias is not applied to the electrodes.

In the case where the forward bias is applied to the organic layer 4 interposed between the light emitting electrode 7 and the common electrode 2, the functional layer 5 functions as an electron transporting layer, and the functional layer 3 functions as a hole transporting layer. Therefore, injection of electrons from the cathode (the light emitting electrode 7) into the organic layer 4 is promoted, and injection of holes from the anode (the common electrode 2) into the organic layer 4 is promoted, so that injected electrons and holes are recombined together in the recombination region (the organic layer 4) to emit light. The functional layers 5, 3 perform also functions of moving electrons and holes injected from the light emitting electrode 7 and the common electrode 2 to the recombination region, and collecting electrons and holes in a local energy region of an interface region to enhance the light emission. In this way, the light emitting electrode 7, the common electrode 2, and the organic layer 4 interposed therebetween constitute the light emitting element 10b.

The forward bias power supply 10 can change the level of the voltage to be applied. Therefore, the emission luminance of the light emitting element 100b can be adjusted by changing the applied voltage.

In the case where the reverse bias is applied to the organic layer 4 interposed between the light receiving electrode 6 and the common electrode 2, the functional layer 5 functions as a hole blocking layer, and the functional layer 3 functions as an electron blocking layer. Therefore, injection of electrons from the cathode (the common electrode 2) into the organic layer 4 is restrained, and injection of holes from the anode (the light receiving electrode 6) into the organic layer 4 is restrained. In this state, when light is incident on the organic layer 4 from the upper side of the sealing substrate 1, electrons are excited to the conduction band (excited state), and holes remain in the valence band (ground state). The electrons and the holes are moved to the respective electrodes in the opposite directions, by an electric field which is generated by the reverse bias, or namely the electrons are moved to the light receiving electrode 6, and the holes are moved to the common electrode 2, thereby producing a signal current. The ammeter 8 is disposed for detecting the signal current. An imaging signal corresponding to an object can be obtained from the output of the ammeter 8. In this way, the light receiving electrode 6, the common electrode 2, and the organic layer 4 interposed therebetween constitute the light receiving element 100a.

The organic layer 4 is made of an organic material (for example, quinacridone, squarylium, or zinc phthalocyanine) which exerts the light emitting function in the application of the forward bias, and the photoelectric converting function in the application of the reverse bias.

The functional layer 3 is made of an organic material (for example, amine TPD) having the electron blocking function and the hole transporting function.

The functional layer 5 is made of an organic material (for example, Alq3 (tris (8-hydroxyquinoline) aluminum)) having the hole blocking function and the electron transporting function.

Hereinafter, the operation of the light emitting/receiving element 100 will be described.

In the case where the light emitting/receiving element 100 is to be used as a light emitting element, by a driving circuit (not shown), the switch for the reverse bias power supply 9 is turned off, and that for the forward bias power supply 10 is turned on, so that the forward bias is applied only to the organic layer 4 between the light emitting electrode 7 and the common electrode 2. As a result, the light emitting element 100b emits light, and the light emitting/receiving element 100 can be used as a light emitting element. By contrast, in the case where the light emitting/receiving element 100 is to be used as a light receiving element, by the driving circuit (not shown), the switch for the reverse bias power supply 9 is turned on, and that for the forward bias power supply 10 is turned off, so that the reverse bias is applied only to the organic layer 4 between the light receiving electrode 6 and the common electrode 2. As a result, a signal corresponding to charges which are obtained by photoelectric conversion in the light receiving element 100a is extracted to the outside, and the light emitting/receiving element 100 can be used as a light receiving (imaging) element.

As described above, the light emitting/receiving element 100 can be used both as a light emitting element and as a light receiving element, simply by switching the switches which are connected to the power supplies. When the light emitting/receiving element 100 is mounted on a portable telephone, for example, the light emitting/receiving element can be used for performing two functions of a light for indicating an incoming call, and a camera for imaging, or the like. This can contribute to miniaturization of the portable telephone, as compared with a portable telephone which has independently a light for indicating an incoming call, and a camera for imaging.

In the configuration example of FIG. 1, the common electrode 2, the functional layer 3, the organic layer 4, and the functional layer 5 are common to the light receiving element 100a and the light emitting element 10b. Alternatively, these components may be configured for each of the light receiving element 100a and the light emitting element 10b. In the case where these components are configured so as to be commoned as shown in FIG. 1, it is not required to perform a patterning process using the photolithography method on the components other than the light receiving electrode 6 and the light emitting electrode 7, and hence the light emitting/receiving element can be easily produced. In the case where the light receiving electrode 6 and the light emitting electrode 7 are previously formed, it is not required to perform a photolithography process after the organic layer is formed above the electrodes, and hence a damage and characteristic degradation of the organic layer due to the photolithography process can be prevented from occurring. Even in the case where the common electrode 2, the functional layer 3, the organic layer 4, and the functional layer 5 are formed for each of the elements, the same material can be used in the elements, and hence only a patterning step is added after the formation of the layers. Therefore, the device can be produced very easily as compared with a conventional element in which light emitting elements and light receiving elements of different constituent materials are arranged on the same face.

In the configuration example of FIG. 1, it is assumed that light is emitted to the upper side of the sealing substrate 1, and an object is placed above the sealing substrate 1, and therefore the common electrode 2 is formed as a transparent electrode. In the case where it is assumed that light is emitted to the lower side of the substrate 11, and an object is placed below the substrate 11, the light receiving electrode 6 and the light emitting electrode 7 may be formed as a transparent electrode. In the case where the common electrode 2 is separately formed for each of the light receiving element and the light emitting element, when the light receiving electrode 6 is transparent, the common electrode 2 which is opposed to the light receiving electrode 6 is opaque, the light emitting electrode 7 is opaque, and the common electrode 2 which is opposed to the light emitting electrode 7 is transparent, it is possible to emit light toward the side opposite to the object. In the case where the light emitting/receiving element is mounted on a portable telephone, when the element is placed in the rear face of the keypad, a configuration is possible where a camera lens is placed in the rear face of the keypad to enable photographing, and light emitted from the light emitting element 100b is used as a backlight for the keypad.

Although, in the above description, the light receiving electrode 6 and the light emitting electrode 7 are configured as separate electrodes, a light emitting/receiving element in which a single electrode is used both as a light receiving electrode and a light emitting electrode may be contemplated.

FIG. 2 is a sectional diagram showing another configuration example of the light emitting/receiving element of the embodiment of the invention. The light emitting/receiving element 200 shown in FIG. 2 has a configuration where all the light emitting electrodes 7 of the light emitting/receiving element 100 shown in FIG. 1 are changed to light receiving electrodes 6, and the forward bias power supply 10 and the reverse bias power supply 9 are connected through a switch 12 between each of the large number of light receiving electrodes 6 and the common electrode 2.

When the light emitting/receiving element 200 is to function as a light emitting element, the switch 12 operates so that a terminal connected to the light receiving electrode 6 is connected to that connected to the forward bias power supply 10 to form a state where the forward bias power supply 10 is connected between the common electrode 2 and the light receiving electrode 6. When the light emitting/receiving element 200 is to function as a light receiving element, the switch operates so that the terminal connected to the light receiving electrode 6 is connected to that connected to the reverse bias power supply 9 to form a state where the reverse bias power supply 9 is connected between the common electrode 2 and the light receiving electrode 6.

Hereinafter, the operation of the light emitting/receiving element 200 will be described.

In the case where the light emitting/receiving element 200 is to be used as a light emitting element, by a driving circuit (not shown), the switch 12 is connected to the side of the forward bias power supply 10, so that the forward bias is applied to the organic layer 4 between the light receiving electrode 6 and the common electrode 2. As a result, the organic layer 4 interposed between the light receiving electrode 6 and the common electrode 2 emits light, and the light emitting/receiving element 200 can be used as a light emitting element. By contrast, in the case where the light emitting/receiving element 200 is to be used as a light receiving element, by the driving circuit (not shown), the switch 12 is connected to the side of the reverse bias power supply 9, so that the reverse bias is applied to the organic layer 4 interposed between the light receiving electrode 6 and the common electrode 2. As a result, a signal corresponding to charges which are obtained by photoelectric conversion in the organic layer 4 between the light receiving electrode 6 and the common electrode 2 is extracted to the outside, and the light emitting/receiving element 200 can be used as a light receiving (imaging) element.

As described above, also in the configuration such as shown in FIG. 2, the light emitting/receiving element 200 can be used both as a light emitting element and as a light receiving element, simply by switching the switch 12. According to the configuration of FIG. 2, a light emitting region and a light receiving region can be formed at the same position, and hence miniaturization is enabled as compared with the configuration of FIG. 1.

Hereinafter, embodiments of a second aspect of the invention will be described with reference to the drawings.

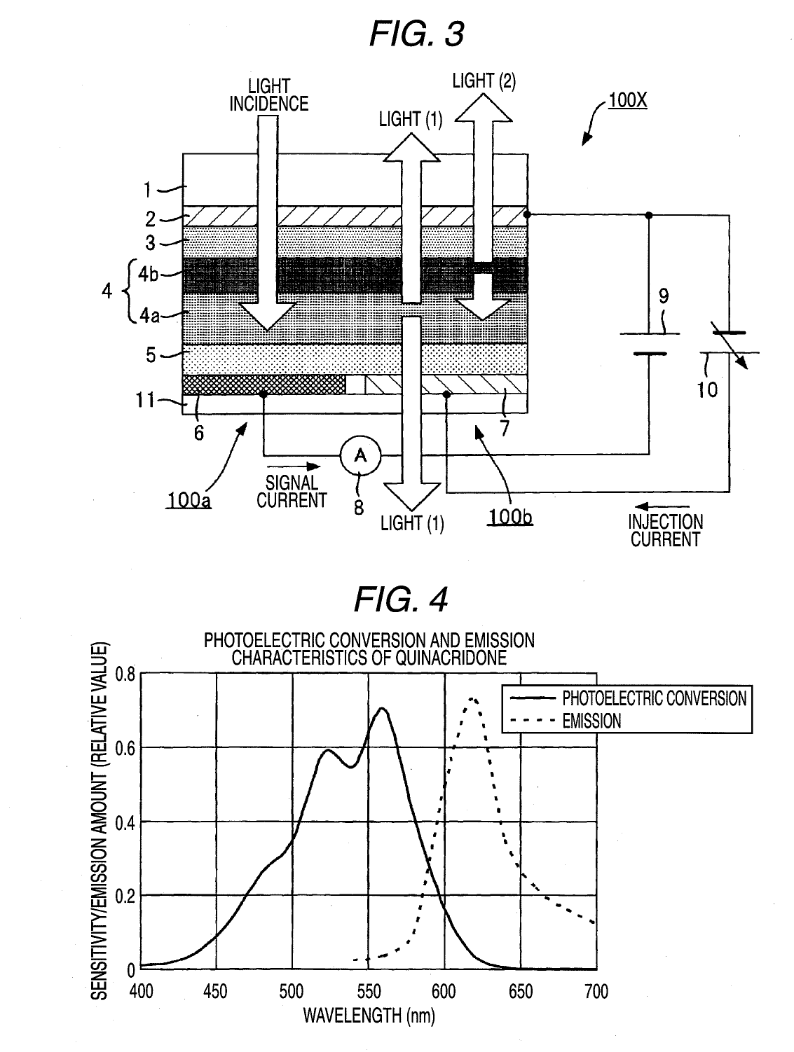

FIG. 3 is a partial sectional diagram schematically showing the configuration of a two-dimensional scanner which is an imaging apparatus of an embodiment of the invention.

The two-dimensional scanner 100X includes a light emitting/receiving unit including a light receiving element 100a and light emitting element 100b which are arranged in close proximity above a substrate 11, and is configured by two-dimensionally arranging a large number of such units on the substrate 11.

Each of the light receiving element 100a and the light emitting element 100b has a basic configuration which is configured by an organic layer and a pair of electrodes sandwiching the organic layer. In the two-dimensional scanner 100X, the organic layer constituting the light receiving element 100a, and that constituting the light emitting element 100b are made of the same material, and bias voltages which are applied respectively to the organic layers are differentiated from each other, thereby enabling the organic layer of the light receiving element 100a to function as a photoelectric converting layer, and that of the light emitting element 100b to function as a light emitting layer.

The two-dimensional scanner 100X includes: the transparent substrate 11 such as glass; a light receiving electrode 6 which is formed on the substrate 11 and at a position where the light receiving element 100a is to be formed, and which is an electrode for the light receiving element 100a; a light emitting electrode 7 which is formed on the substrate 11 and at a position where the light emitting element 100b is to be formed, and which is an electrode for the light emitting element 100b; a functional layer 5 which is formed on the light receiving electrode 6 and the light emitting electrode 7, and which has an electron blocking function and a hole transporting function; an organic layer 4 which is formed on the functional layer 5; a functional layer 3 which is formed on the organic layer 4, and which has a hole blocking function and an electron transporting function; a common electrode 2 which is formed on the functional layer 3, and which has a single-layer structure that is common to the light receiving element 100a and the light emitting element 100b; a transparent sealing substrate 1 such as glass which is formed on the common electrode 2; a reverse bias power supply 9 which is connected between the light receiving electrode 6 and the common electrode 2; a forward bias power supply 10 which is connected between the light emitting electrode 7 and the common electrode 2; and an ammeter 8 which is connected between the light receiving electrode 6 and the reverse bias power supply 9, and which is a current detecting unit.

Each of the functional layer 3, the organic layer 4, and the functional layer 5 is formed as a single layer which is common to the light receiving element 100a and the light emitting element 10b. The common electrode 2 is made of a material (for example, ITO) which is transparent to visible light so that light generated in the organic layer 4 can upward pass through the electrode, and light incident from the upper side can enter the organic layer 4. The light receiving electrode 6 is made of a material (for example, a metal such as aluminum) which is opaque to visible light so that light does not enter from the lower side the organic layer 4 interposed between the electrode and the common electrode 2. The light emitting electrode 7 is made of a material (for example, ITO) which is transparent to visible light so that light generated in the organic layer 4 can downward pass through the electrode.

The forward bias power supply 10 is used for applying a bias voltage for injecting charges (holes and electrons) from the light emitting electrode 7 and the common electrode 2 into the organic layer 4 interposed between the light emitting electrode 7 and the common electrode 2 (hereinafter, such a bias voltage is referred to as forward bias), to the light emitting electrode 7 and the common electrode 2. The forward bias power supply 10 can be changed by a switch (not shown) between a state where the forward bias is applied to the light emitting electrode 7 and the common electrode 2, and that where the forward bias is not applied to the electrodes. The forward bias power supply 10 is formed as a voltage variable power supply which can change the level of the voltage to be applied.

The reverse bias power supply 9 is used for applying a bias voltage which moves charges generated in the organic layer 4 interposed between the light receiving electrode 6 and the common electrode 2, to the light receiving electrode 6 and the common electrode 2, and which is opposite in polarity to the forward bias (hereinafter, such a bias voltage is referred to as reverse bias), to the light receiving electrode 6 and the common electrode 2. The reverse bias power supply 9 can be changed by a switch (not shown) between a state where the reverse bias is applied to the light receiving electrode 6 and the common electrode 2, and that where the reverse bias is not applied to the electrodes.

In the case where the forward bias is applied to the organic layer 4 interposed between the light emitting electrode 7 and the common electrode 2, the functional layer 5 functions as a hole transporting layer, and the functional layer 3 functions as an electron transporting layer. Therefore, injection of holes from the cathode (the light emitting electrode 7) into the organic layer 4 is promoted, and injection of electrons from the anode (the common electrode 2) into the organic layer 4 is promoted, so that injected electrons and holes are recombined together in the recombination region (the organic layer 4) to emit light. The functional layers 5, 3 perform also functions of moving electrons and holes injected from the light emitting electrode 7 and the common electrode 2 to the recombination region, and collecting electrons and holes in a local energy region of an interface region to enhance the light emission. In this way, the light emitting electrode 7, the common electrode 2, and the organic layer 4 interposed therebetween constitute the light emitting element 10b.

The forward bias power supply 10 can change the level of the voltage to be applied. Therefore, the emission luminance of the light emitting element 100b can be adjusted by changing the applied voltage.

In the case where the reverse bias is applied to the organic layer 4 interposed between the light receiving electrode 6 and the common electrode 2, the functional layer 5 functions as an electron blocking layer, and the functional layer 3 functions as a hole blocking layer. Therefore, injection of holes from the cathode (the common electrode 2) into the organic layer 4 is restrained, and injection of electrons from the anode (the light receiving electrode 6) into the organic layer 4 is restrained. In this state, when light is incident on the organic layer 4 from the upper side of the sealing substrate 1, electrons are excited to the conduction band (excited state), and holes remain in the valence band (ground state). The electrons and the holes are moved to the respective electrodes in the opposite directions, by an electric field which is generated by the reverse bias, or namely the holes are moved to the light receiving electrode 6, and the electrons are moved to the common electrode 2, thereby producing a signal current. The ammeter 8 is disposed for detecting the signal current. An imaging signal corresponding to an object can be obtained from the output of the ammeter 8. In this way, the light receiving electrode 6, the common electrode 2, and the organic layer 4 interposed therebetween constitute the light receiving element 100a.

The organic layer 4 may be made of an organic material (for example, quinacridone, squarylium, or zinc phthalocyanine) which exerts the light emitting function in the application of the forward bias, and the photoelectric converting function in the application of the reverse bias. In such an organic material, electrons which are injected in the excited state of the organic material by the voltage application, and holes which are injected in the ground state are moved in the organic substance by the driving of the electric field, and recombined with each other to emit light. In the case where electrons in the ground state are excited by light, the electron transition time is substantially zero. By contrast, electrons in the ground state have a certain lifetime, and, during the time, the energy of electrons is changed to other energies such as lattice vibration to be lost. Therefore, the emission wavelength of such an organic material is shifted (Stokes-shifted) with respect to the absorption wavelength toward a longer wavelength corresponding to an energy which is lower than the excitation energy.

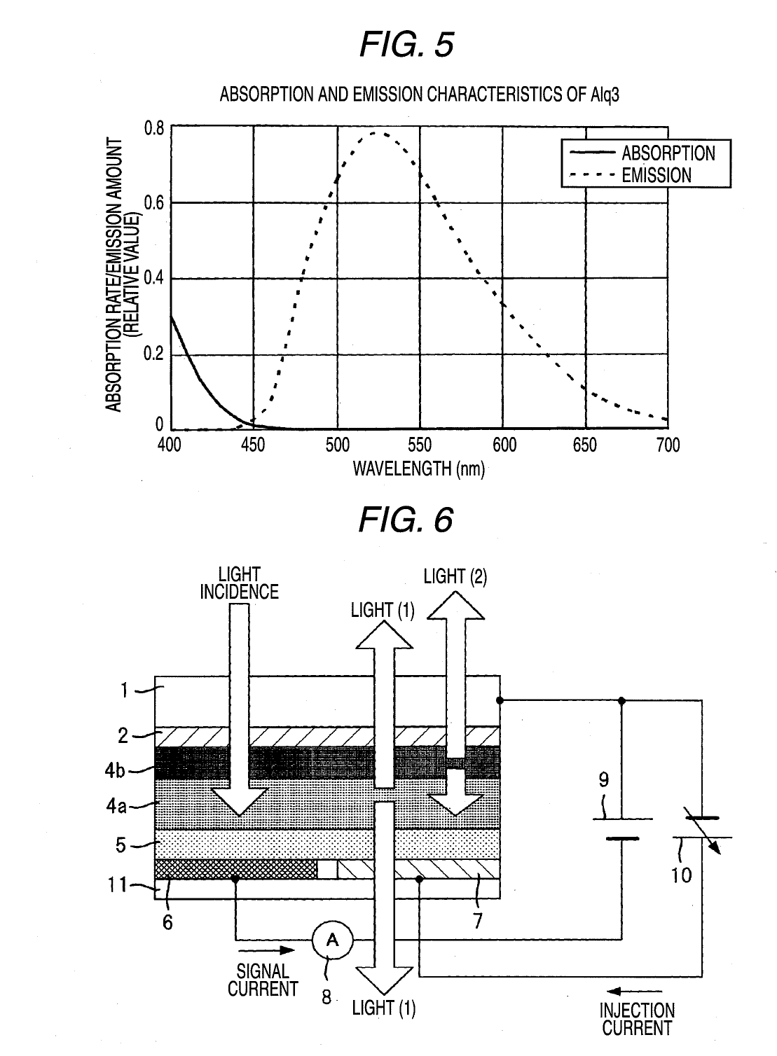

In quinacridone which is well known as a photoelectric converting layer for detecting green light in an organic sensor, as shown in FIG. 4, for example, a peak of the absorption wavelength is in the vicinity of 560 nm in the case where quinacridone is used as an image sensor, and, in contrast, a peak of the emission wavelength is in the vicinity of 610 nm in the case where quinacridone is used as a light emitting layer of an organic EL. In Alq3 which is often used as a hole-blocking material, as shown in FIG. 5, a peak of the absorption wavelength is in the ultraviolet region. Therefore, Alq3 is transparent in the visible light region. In the case where Alq3 is used as a light emitting layer of an organic EL, however, a peak of the emission wavelength is in the vicinity of 520 nm, or shifted to a longer wavelength.

In the case where the organic layer 4 is configured by a single organic material, namely, the wavelength region of light which can be detected by the light receiving element 100a, and that of light which can be emitted from the light emitting element 100b do not overlap with each other, and hence the light emitting element 100b cannot be used as an element for illuminating an object when the light receiving element 100a performs imaging. The two-dimensional scanner 100X of the embodiment has functions of irradiating a portion to be scanned, with light, and receiving light reflected from the scanned object to obtain an image of the scanned object. In the case where the organic layer 4 is configured by a single organic material, however, it is difficult to realize these functions. In the embodiment, therefore, the organic layer 4 is configured by a two-layer structure of an organic layer 4a formed on the functional layer 5, and an organic layer 4b formed on the organic layer 4a, so that these functions can be realized.

The organic layer 4a is made of an organic material that, in the application of the reverse bias, exhibits an absorption spectrum in which light of a specific wavelength range is absorbed. The organic layer 4b is made of an organic material in which the transmission wavelength range in the application of the reverse bias overlaps with the absorption wavelength range of the organic layer 4a in the application of the reverse bias, and the emission wavelength range in the application of the forward bias overlaps with the absorption wavelength range of the organic layer 4a in the application of the reverse bias. In the case where light in the specific wavelength range is that in the green wavelength range, for example, the organic layer 4a may be made of quinacridone, and the organic layer 4b may be made of Alq3.

When the materials are selected in this way, the light emitting element 100b emits light so that the object can be irradiated with green light (LIGHT (2) in FIG. 3) and green light (LIGHT INCIDENCE in FIG. 3) reflected from the object can be absorbed by the light receiving element 100a, thereby enabling imaging of the object. As indicated by LIGHT (1) in FIG. 3, the organic layer 4a of the light emitting element 100b emits light in the wavelength range indicated by the broken line in FIG. 4, to the upper side of the sealing substrate 1 and the lower side of the substrate 11. LIGHT (1) which is emitted to the upper side of the sealing substrate 1 impinges the object, but the wavelength range of the light reflected from the object does not largely overlap with the absorption wavelength of the organic layer 4b, with the result that LIGHT (1) is not substantially detected in the organic layer 4a. By contrast, LIGHT (1) which is emitted to the lower side of the substrate 11 can be used as display light, and the result of the scanning operation can be displayed by using LIGHT (1).

The functional layer 3 is made of an organic material (such as Alq3) having the hole blocking function and the electron transporting function. Since a material which can be used both as the functional layer 3 and the organic layer 4b, such as Alq3 exists, the two-dimensional scanner 100X may be configured so that, as shown in FIG. 6, the functional layer 3 is omitted and the organic layer 4b is used also as the functional layer 3. According to the configuration, thinning of an element can be realized.

The functional layer 5 is made of an organic material (for example, amine TPD) having the electron blocking function and the hole transporting function.

In the configuration example of FIG. 3, the common electrode 2, the functional layer 3, the organic layer 4, and the functional layer 5 are common to the light receiving element 100a and the light emitting element 10b. Alternatively, these components may be configured for each of the light receiving element 100a and the light emitting element 10b. In the case where these components are configured so as to be commoned as shown in FIG. 3, it is not required to perform a patterning process using the photolithography method on the components other than the light receiving electrode 6 and the light emitting electrode 7, and hence the two-dimensional scanner 100X can be easily produced. In the case where the light receiving electrode 6 and the light emitting electrode 7 are previously formed, it is not required to perform a photolithography process after the formation of the organic layer to be thereafter formed, and hence a damage and characteristic degradation of the organic layer due to the photolithography process can be prevented from occurring.

Even in the case where the common electrode 2, the functional layer 3, the organic layer 4, and the functional layer 5 are formed for each of the elements, the same material can be used in the elements, and hence the elements can be produced by the same process. Therefore, the production can be very easily performed as compared with the conventional art in which light emitting elements and light receiving elements of different constituent materials are arranged on the same face.

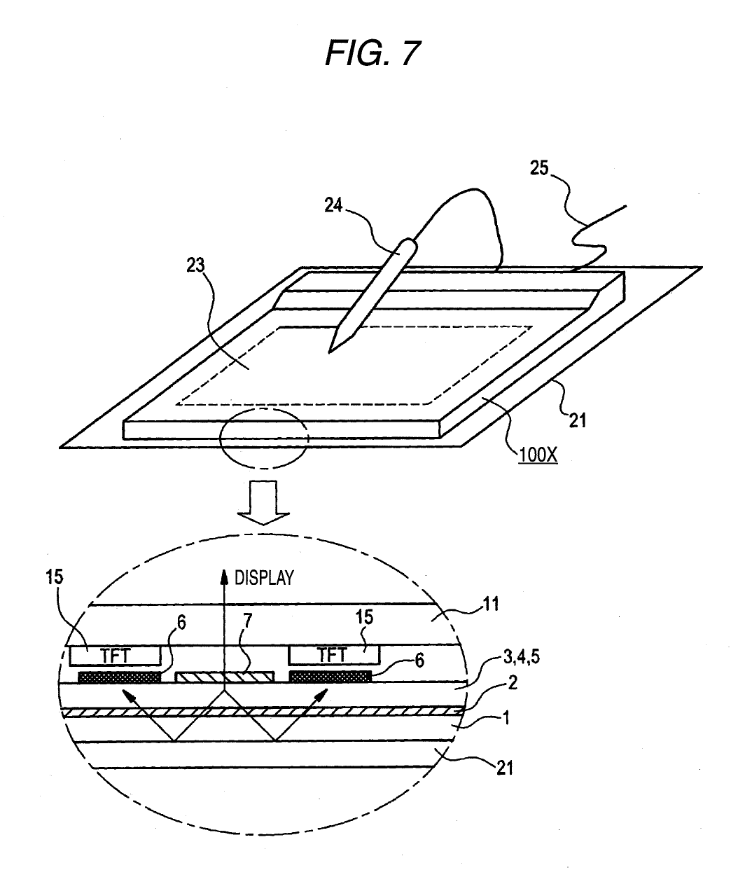

FIG. 7 is a view showing the whole configuration of the two-dimensional scanner 100X of the embodiment. In FIG. 7, the components identical with those of FIG. 3 are denoted by the same reference numerals.

As shown in FIG. 7, the two-dimensional scanner 100X is used while the sealing substrate 1 is closely contacted with an object 21 such as a document. The large number of light emitting electrodes 7 which can be seen through the substrate 11 in the state where the sealing substrate 1 is closely contacted with the object 21 can emit light, and the light emitting electrodes 7 constitute a displaying unit 23 in which the electrodes function as display pixels. A USB cable 25 through which signals obtained from the light receiving elements 100a are supplied to the outside, and a touch pen 24 which is used for inputting characters into the displaying unit 23 are connected to the two-dimensional scanner 100X. Although not shown in FIG. 3, a driving circuit 15 configured by TFTs which are connected to the light receiving electrodes 6 and the light emitting electrodes 7, wirings, a power supply, and the like is formed between the light receiving electrodes 6 and the substrate 11.

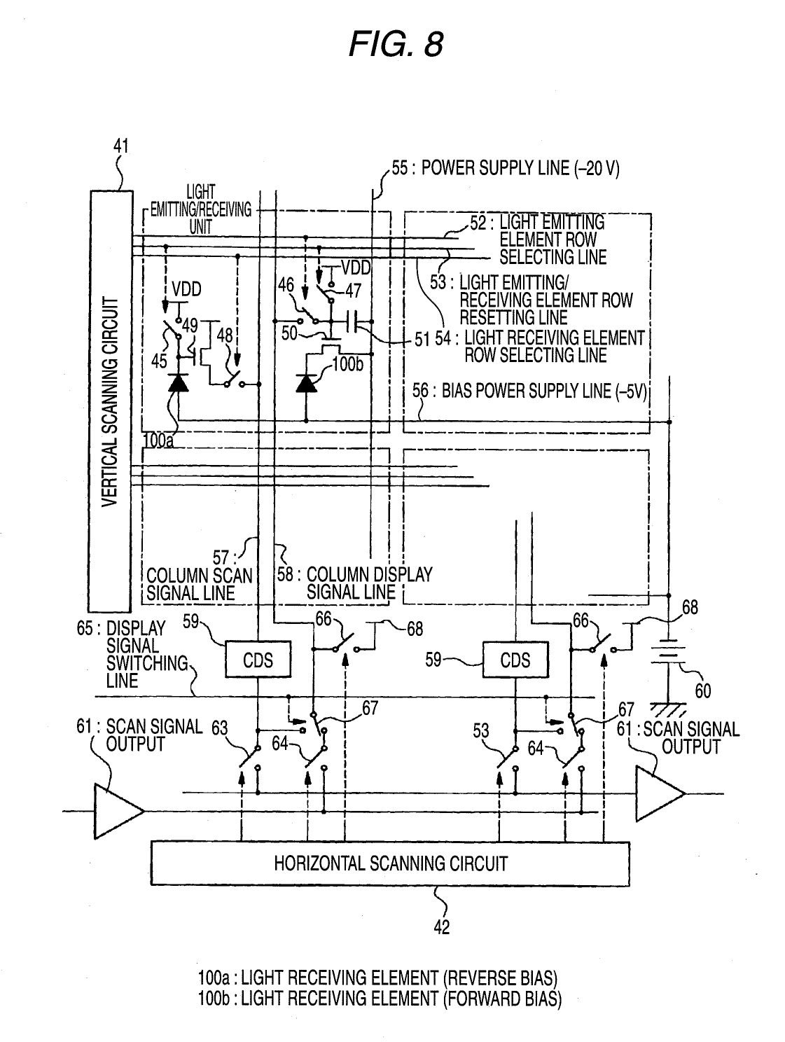

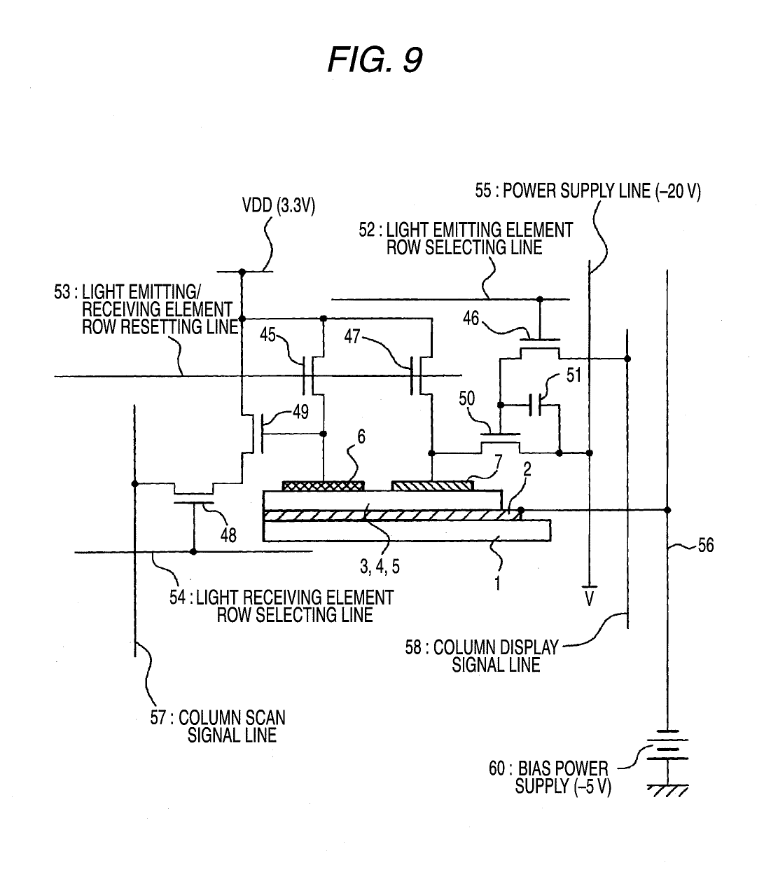

FIG. 8 is a diagram schematically showing the configuration of the driving circuit 15 of the two-dimensional scanner 100X, and FIG. 9 is an enlarged view of the light emitting/receiving unit shown in FIG. 8. FIG. 8 shows an equivalent circuit of the circuit shown in FIG. 9.

The driving circuit 15 of the two-dimensional scanner 100X includes transistors 45 to 50, capacitors 51, light emitting element row selecting lines 52, light emitting/receiving element row resetting lines 53, light receiving element row selecting lines 54, power supply lines 55, column scan signal lines 57, column display signal lines 58, a power supply VDD, a bias power supply 60, a vertical scanning circuit 41, a horizontal scanning circuit 42, CDS circuits 59, a scan signal outputting unit 61, a display signal inputting unit 62, a display signal switching line 65, switches 63, 64, 66, 67, and a pulse generating unit 68.

In each of the light receiving elements 100a, the drain of the reset transistor 45 is connected to the light receiving electrode 6, and the gate of the output transistor 49 corresponding to the ammeter 8 is connected to the drain of the reset transistor 45. The power supply VDD (3.3 V) is connected to the sources of the reset transistor 45 and the output transistor 49. The source of the row selection transistor 48 is connected to the drain of the output transistor 49, the light receiving element row selecting line 54 is connected to the gate of the row selection transistor 48, and the column scan signal line 57 is connected to the drain of the row selection transistor 48.

The drain of the reset transistor 47 is connected to the light emitting electrode 7 of the light emitting element 10b, and that of the input transistor 50 is connected to the drain of the reset transistor 47. The power supply VDD is connected to the source of the reset transistor 47. The light emitting/receiving element row resetting line 53 is connected to the gates of the reset transistors 45, 47. The capacitor 51 is connected between the gate and source of the input transistor 50. The drain of the row selection transistor 46 is connected to the gate of the input transistor 50. The light emitting element row selecting line 52 is connected to the gate of the row selection transistor 46, and the column display signal line 58 is connected to the source of the row selection transistor 46. A power supply V (−20 V) is connected to the source of the input transistor 50 through the power supply line 55.

The bias power supply 60 is connected to the common electrode 2 through a bias power supply line 56. The bias power supply 60 and the power supply VDD constitute the reverse bias power supply 9, and the bias power supply 60, the row selection transistor 46, the power supply V, the input transistor 50, and the capacitor 51 constitute the forward bias power supply 10.

The light emitting element row selecting line 52, the light emitting/receiving element row resetting line 53, and the light receiving element row selecting line 54 are connected to the vertical scanning circuit 41, and the circuit supplies a pulse. Sets each consisting of the light emitting element row selecting line 52, the light emitting/receiving element row resetting line 53, and the light receiving element row selecting line 54 are disposed correspondingly with and on the upper sides of unit rows of plural light emitting/receiving units which are arranged in the horizontal direction, respectively. The power supply lines 55 are placed correspondingly with and on the right sides of unit columns of plural light emitting/receiving units which are arranged in the vertical direction, respectively.

The column scan signal lines 57 are connected to the CDS circuits 59 which are disposed respectively for the unit columns, and the column display signal lines 58 are connected to the CDS circuits 59 through the switches 67, respectively. Each of the switches 67 is a switch for selecting the connection of the output of the corresponding CDS circuit 59 and the correspond column display signal line 58 or that of the column display signal line 58 and the display signal inputting unit 62. The switch 67 is connected also to the display signal switching line 65, and the connection destination is controlled by a pulse supplied through the line. The switches 64 which are controlled by the horizontal scanning circuit 42 are connected between the switches 67 and the display signal inputting unit 62.

The outputs of the CDS circuits 59 are connected to the scan signal outputting unit 61 through the switches 63 which are controlled by the horizontal scanning circuit 42, and also to the column display signal lines 58 through the switches 67.

The pulse generating unit 68 which generates a horizontal coordinate pulse for the touch pen 24 is connected to the column display signal lines 58 through the switches 66 which are controlled by the horizontal scanning circuit 42.

Next, the operation of the two-dimensional scanner 100X in the case where the object is scanned and the result of the scan is displayed on the displaying unit 23 will be described. At the timing of starting the operation, a state is attained where the pulse is not applied to the display signal switching line 65, and the switches 67 are connected to the respective CDS circuits 59.

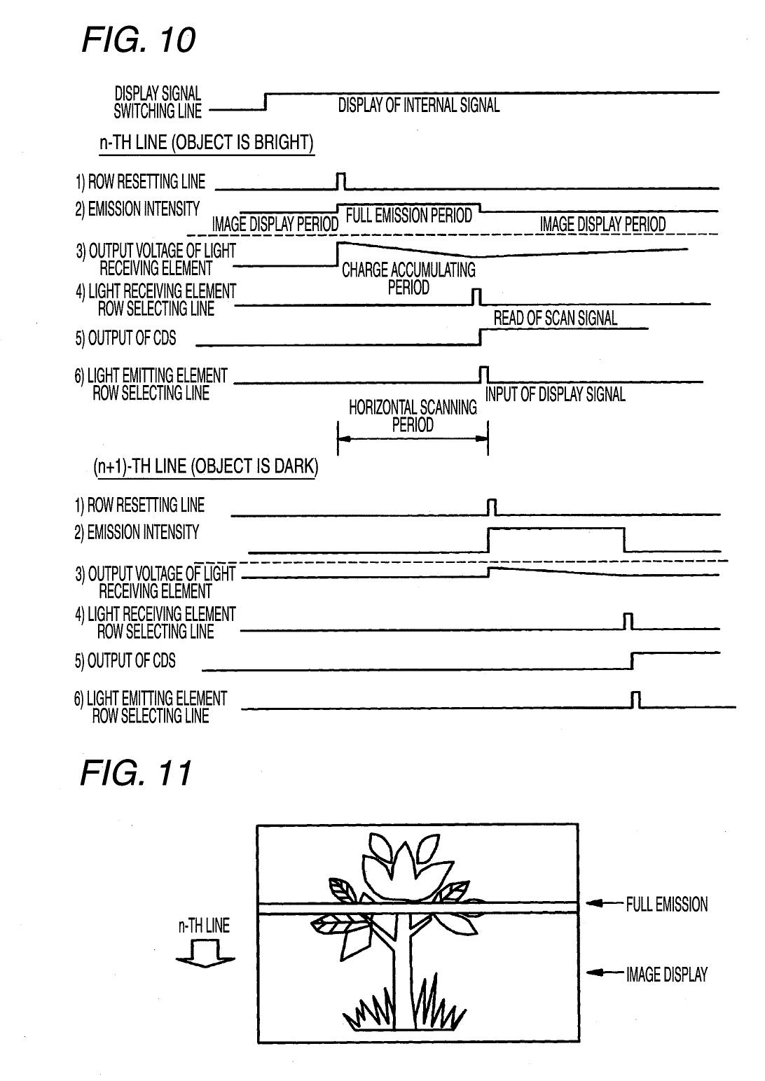

FIG. 10 is a chart showing the operation timing of the two-dimensional scanner 100X in the case where the scan result is to be displayed on the displaying unit 23.

First, the vertical scanning circuit 41 applies a pulse to the light emitting/receiving element row resetting line 53 corresponding to a unit row of an n-th line. Then, a voltage of 3.3 V is supplied from the power supply VDD to the light receiving electrode 6 to attain a state where the reverse bias is applied to the organic layer 4 of the light receiving element 100a. The capacitor 51 is charged by the voltage value through the power supply line 55, and a voltage of −20 V corresponding to the voltage value is applied to the light emitting electrode 7 to obtain a state where the forward bias is applied to the organic layer 4 of the light emitting element 10b. In this state, the light emitting element 100b performs full light emission, and illuminates the object 21, and the light receiving element 100a starts to be exposed.

After the exposure period is ended, when the pulse is applied to the light receiving element row selecting line 54, charges which are generated in the organic layer 4 of the light receiving element 100a and then moved to the light receiving electrode 6 are converted to a scan signal by the output transistor 49, and the signal is supplied from the row selection transistor 48 to the column scan signal line 57. The scan signal supplied to the column scan signal line 57 undergoes a noise removal process in the CDS circuit 59. When the switch 63 is turned on by the horizontal scanning circuit 42, the scan signal after the noise removal is supplied to the scan signal outputting unit 61, and amplified therein to be supplied to the outside.

On the other hand, the scan signal after the noise removal is supplied to the column display signal line 58 via the switch 67. When a pulse is applied to the light emitting element row selecting line 52, the scan signal supplied to the column display signal line 58 is converted by the transistor 46 to a forward bias voltage corresponding to the amount of the signal, the voltage level is held by the capacitor 51, and the voltage level held by the capacitor 51 is supplied to the light emitting electrode 7. As a result, the light emitting elements 100b of the unit row of the n-th line emit light corresponding to the scan signal toward the side opposite to the side of the object 21, so that the result of the scan of the n lines is displayed on the displaying unit 23. This display is performed during when the amount of the signal is held by the capacitor 51.

The operation is repeated while n is incremented or n→n+1, to scan the whole image of the object, and the result of the scan is displayed on the displaying unit 23.

When the operation is performed, vertical movement of a strip (having a width corresponding one line) of light is repeated in the image display on the displaying unit 23 as shown in FIG. 11. However, the speeds of the scan and display per screen are about 1/30 sec., the average contrast change is equal to the quotient of the division by the vertical line number, and therefore the movement does not substantially hinder the display.

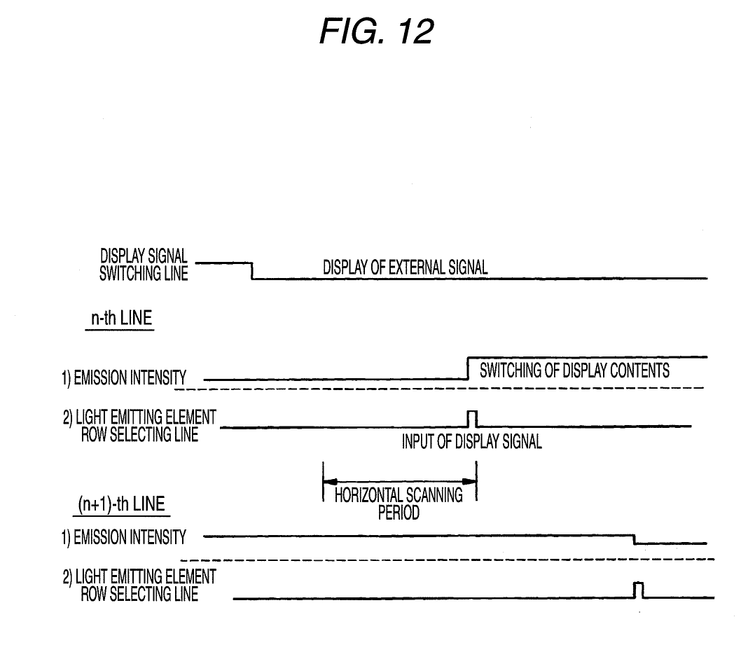

In the above description, the scan result is displayed on the displaying unit 23. An image which is completely different from the result may be displayed on the displaying unit 23. In this case, a pulse is applied to the display signal switching line 65 to connect the switches 67 to the sides of the switches 64. In this state, as shown in FIG. 12, the switches 64 are sequentially turned on in the horizontal direction under the control of the horizontal scanning circuit 42, and the light emitting element row selecting lines 52 are sequentially made on, whereby the light emitting elements 100b are enabled to emit light corresponding to the signal supplied to the display signal inputting unit 62, so that an arbitrary image can be displayed.

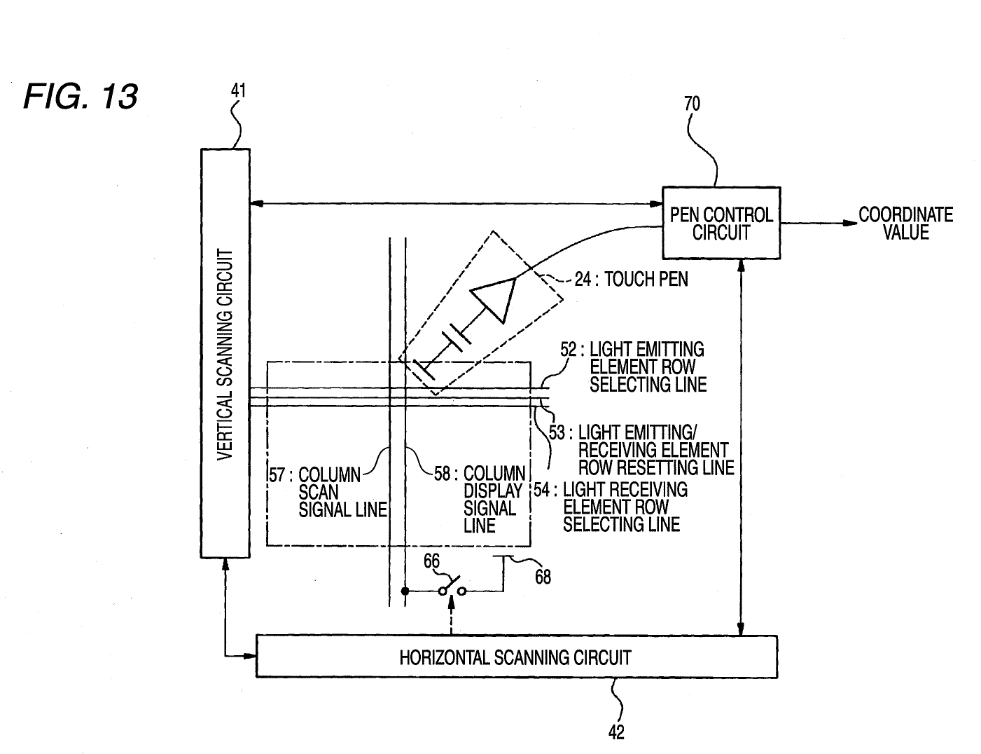

Also, information hand-written by means of the touch pen 24 can be displayed on the displaying unit 23. FIG. 13 is a simplified diagram of the circuit shown in FIG. 8. In the touch pen 24, as shown in FIG. 13, a minute coil or electrode attached to the tip end detects, by means of electrostatic or electromagnetic induction, the horizontal coordinate pulse which is applied from the pulse generating unit 68 to the column display signal lines 58, and a detection result is supplied to a pen control circuit 70. The pen control circuit 70 calculates the horizontal and vertical coordinates from timings when the pulses are applied to the light emitting element row selecting lines 52, the light emitting/receiving element row resetting lines 53, and the light receiving element row selecting lines 54, and the timing when the pulse is applied to the column display signal lines 58.

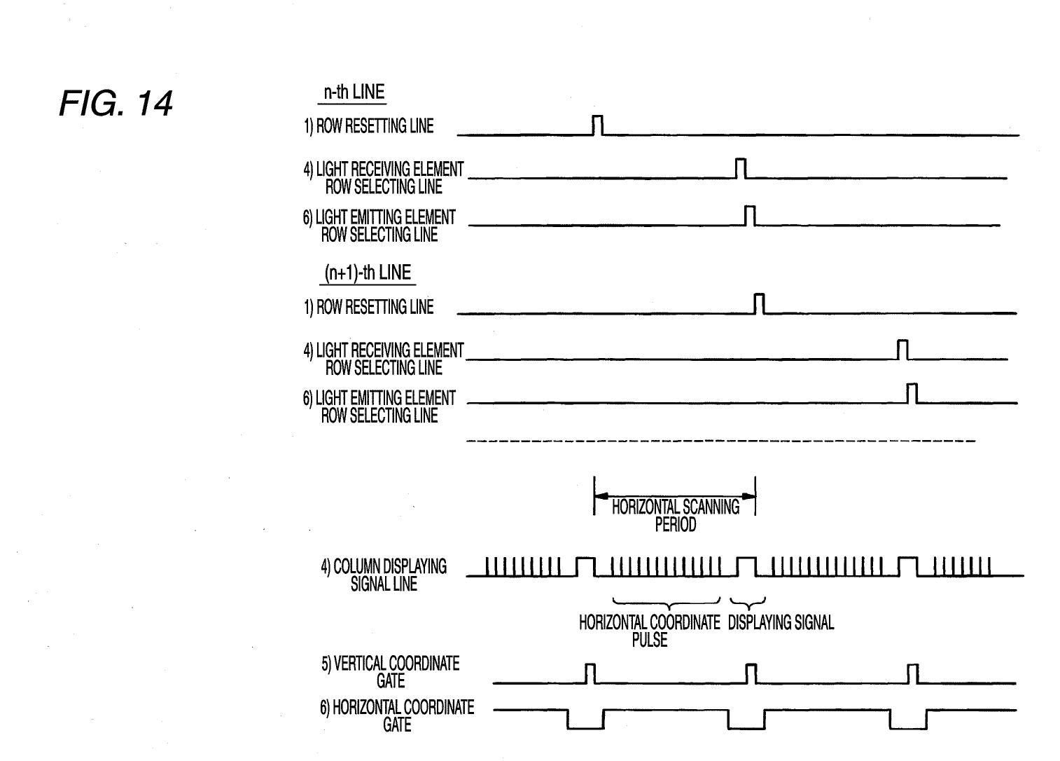

FIG. 14 is a timing chart for calculating the coordinates.

When the output signal of the touch pen 24 is gated by a vertical coordinate gate of the timing chart shown in FIG. 14, only the pulse applied to the light emitting element row selecting lines 52 is detected. The vertical coordinate of the touch pen is obtained by comparing the generation timing of the pulse with the timing of the vertical scan. When the output signal of the touch pen is gated by a horizontal coordinate gate of the timing chart shown in FIG. 14, similarly, only the pulse applied to the column display signal lines 58 is detected. The horizontal coordinate of the touch pen is obtained by comparing the generation timing of the pulse with the timing of the horizontal scan.

The thus obtained horizontal and vertical coordinates are fed back to the display signal inputting unit 62, and the light emitting element 100b at the coordinates is caused to emit light in accordance with the contents which are input by means of the touch pen 24, thereby enabling characters or the like to be freely overwritten on the scan result by means of the touch pen 24.

As described above, the two-dimensional scanner of the embodiment can perform a scanning operation while being closely contacted with an object. Without using an optical system such as an imaging lens and the like, therefore, image information of the resolution corresponding to the number of the light receiving elements 100a can be read. Since an optical system is not required, the scanner can be thinned as compared with a usual scanner, and, for example, even a middle portion of a thick book which is hardly scanned can be easily scanned by inserting the two-dimensional scanner 100X to the portion in such a manner that a bookmark is inserted into the book. When the distance between the organic layer 4 and the object 21 is set to about one half to twice the arrangement pitch of the light receiving electrode 6 and the light emitting electrode 7, it is possible to obtain a satisfactory scan result without disposing an optical system.

In the two-dimensional scanner of the embodiment, depending on the bias voltage applied to the single organic layer 4, the organic layer can function as either of a photoelectric converting layer and a light emitting layer. Therefore, the scanner can be produced easily as compared with a conventional art in which a photoelectric converting layer and a light emitting layer are made of different materials, and the production cost can be largely reduced.

In the two-dimensional scanner of the embodiment, in the line under scan, the light emitting elements 100b function as an illuminating element, and, when the scanning operation is ended, the light emitting elements 100b of the line function as a display unit on which a result of the scan is to be displayed. While scanning an image, therefore, the scan result can be checked in real time. This is useful in checking a scan failure.

In the two-dimensional scanner of the embodiment, information can be additionally written in the scan result by means of the touch pen 24. Therefore, the scanner is highly convenient. Furthermore, this function is realized by using the selection and signal lines which are disposed for scanning and displaying, and without disposing additional signal lines, and hence the scanner is simple in structure and economical. Moreover, an optical pen or the like which emits light is not used. Consequently, the scanner is not affected by external light, and hence is highly reliable.

Hereinafter, embodiments of a third aspect of the invention will be described with reference to the drawings.

### First Embodiment

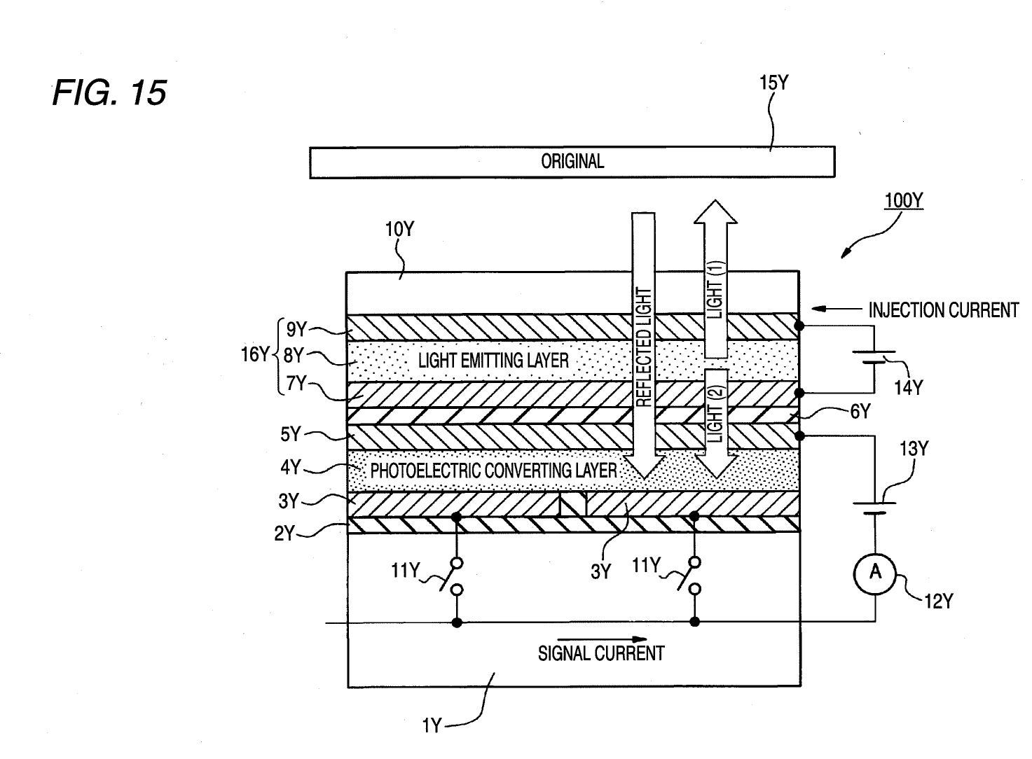

FIG. 15 is a partial sectional diagram schematically showing the configuration of an imaging device of a first embodiment of the invention.

The imaging device 100Y shown in FIG. 15 includes: a substrate 1Y such as a glass substrate or a semiconductor substrate; an insulating layer 2Y which is formed on the substrate 1Y; a plurality of pixel electrodes 3Y which are arranged one- or two-dimensionally on the insulating layer 2Y; a photoelectric converting layer 4Y which is formed on the pixel electrodes 3Y; an opposing electrode 5Y which is formed on the photoelectric converting layer 4Y; an insulating layer 6Y which is formed on the opposing electrode 5Y; a light emitting element 16Y consisting of a transparent electrode 7Y which is formed on the insulating layer 6Y, a light emitting layer 8Y which is formed on the transparent electrode 7Y, and a transparent electrode 9Y which is formed on the light emitting layer 8Y; a protective layer 10Y which is formed on the transparent electrode 9Y; switches 11Y each configured by a transistor; and an ammeter 12Y. A power supply 13Y is connected between the ammeter 12Y and the opposing electrode 5Y, and a power supply 14Y is connected between the transparent electrode 7Y and the transparent electrode 9Y. The power supplies 13Y, 14Y are disposed in a scanner that is an imaging apparatus on which the imaging device 100Y is mounted.

The imaging device 100Y is used while the protective layer 10Y is closely contacted with an original 15Y, and configured so that light emitted from the light emitting layer 8Y impinges on the original 15Y, and the photoelectric converting layer 4Y detects light reflected from the original 15Y, thereby imaging the contents of the original 15Y.

The protective layer 10Y is made of a material through which light emitted from the light emitting layer 8Y can be transmitted.

In order to allow light which is emitted from the light emitting layer 8Y and reflected from the original 15Y to be transmitted through the light emitting layer to the lower side and enter the photoelectric converting layer 4Y, the light emitting layer 8Y is made of a light emitting material in which the emission wavelength range is different from the absorption wavelength range. As the light emitting material, either of an inorganic material or an organic material can be used as far as the emission wavelength range is different from the absorption wavelength range. For example, Alq3 which is an organic material allows most of light which is emitted by itself, to be transmitted therethrough as shown in FIG. 5, and hence can be preferably used as the material of the light emitting layer 8Y.

The transparent electrode 9Y must allow the light emitted from the light emitting layer 8Y to enter the original 15Y, and hence is made of a material which allows at least light of the emission wavelength range of the light emitting layer 8Y to be transmitted therethrough. An example of the material of the transparent electrode 9Y is ITO.

The transparent electrode 7Y must allow the light emitted from the light emitting layer 8Y and reflected from the original 15Y to enter the photoelectric converting layer 4Y, and hence is made of a material which allows at least light of the emission wavelength range of the light emitting layer 8Y to be transmitted therethrough. An example of the material of the transparent electrode 7Y is ITO.

The power supply 14Y is used for applying a bias voltage for injecting charges (holes and electrons) into the transparent electrode 7Y and the transparent electrode 9Y, to the transparent electrode 7Y and the transparent electrode 9Y. In the case where a bias voltage is applied to the light emitting layer 8Y interposed between the transparent electrode 7Y and the transparent electrode 9Y, injection of holes from the cathode (the transparent electrode 9Y) into the light emitting layer 8Y is promoted, and injection of electrons from the anode (the transparent electrode 7Y) into the light emitting layer 8Y is promoted, so that injected electrons and holes are recombined together in the recombination region (the light emitting layer 8Y) to emit light.

The insulating layer 6Y is made of a material which allows at least the light emitted from the light emitting layer 8Y to be transmitted therethrough.

The opposing electrode 5Y must allow the light emitted from the light emitting layer 8Y and reflected from the original 15Y to enter the photoelectric converting layer 4Y, and hence is made of a material which allows at least light of the emission wavelength range of the light emitting layer 8Y to be transmitted therethrough. An example of the material of the opposing electrode 5Y is ITO.

The photoelectric converting layer 4Y must absorb the light emitted from the light emitting layer 8Y and reflected from the original 15Y, and hence is made of an organic or inorganic photoelectric converting material in which the absorption wavelength range has an overlap with the emission wavelength range of the light emitting layer 8Y. In the case where Alq3 is employed as the light emitting layer 8Y, for example, it is preferable to use quinacridone that is an organic material in which the absorption wavelength range is substantially identical with the emission wavelength range of Alq3 as shown in FIG. 4.

The pixel electrode 3Y is an electrode for capturing charges which are generated in the region interposed between the pixel electrode 3Y of the photoelectric converting layer 4Y and the opposing electrode 5Y. The ammeter 12Y is connected to the pixel electrode 3Y through the switch 11Y. When the switch 11Y is turned on, a signal (signal current) corresponding to charges captured by the pixel electrode 3Y is detected by the ammeter 12Y. The power supply 13Y is connected to the opposing electrode 5Y so that, when a bias voltage is supplied from the power supply 13Y, charges generated in the photoelectric converting layer 4Y can be moved to the pixel electrode 3Y.

The portion of the opposing electrode 5Y which overlaps with the pixel electrode 3Y, that of the photoelectric converting layer 4Y which overlaps with the pixel electrode 3Y, and the pixel electrode 3Y constitute one photoelectric converting element. As described above, the imaging device 100Y includes a plurality of photoelectric converting elements which are arranged one- or two-dimensionally above the substrate 1Y, and is configured so that the light emitting element 16Y is disposed above the plural photoelectric converting elements.

Next, the operation of a scanner on which the thus configured imaging device 100Y is mounted will be described.

When instructions for starting an scanning operation is given in a state where the protective layer 10Y of the imaging device 100Y is closely contacted with the original 15Y, the supplies of the bias voltages from the power supplies 13Y, 14Y are started, and light is emitted from the light emitting layer 8Y for a predetermined time period. In the light emitted from the light emitting layer 8Y, light (LIGHT (1) in FIG. 15) directed to the side opposite to the photoelectric converting layer 4Y is transmitted through the transparent electrode 9Y and the protective layer 10Y to impinge on the original 15Y. Reflected light from the original is transmitted through the protective layer 10Y, the transparent electrode 9Y, the light emitting layer 8Y, the transparent electrode 7Y, the insulating layer 6Y, and the opposing electrode 5Y in this sequence, and then impinges on the photoelectric converting layer 4Y. By contrast, in the light emitted from the light emitting layer 8Y, light (LIGHT (2) in FIG. 15) directed to the side the photoelectric converting layer 4Y is transmitted through the transparent electrode 7Y, the insulating layer 6Y, and the opposing electrode 5Y in this sequence, and then impinges on the photoelectric converting layer 4Y.

In the photoelectric converting layer 4Y, charges are generated in accordance with the impinging light. The charges are captured by the pixel electrode 3Y. When the illumination time period of the light emitting layer 8Y is ended, the switches 11Y are sequentially turned on, signals corresponding to charges captured by the pixel electrodes 3Y of the photoelectric converting elements are sequentially detected by the ammeter 12Y, and then output as an imaging signal to the outside. Thereafter, a predetermined signal process is applied to the imaging signal output from the imaging device 100Y to produce image data. The image data are displayed on a display device disposed on the scanner, recorded in a recording medium in the scanner, or transferred to a computer or like connected to the scanner, and then the scanning operation is ended.

As described above, the imaging device 100Y of the embodiment can perform a scanning operation while being closely contacted with an object. Without using an optical system such as an imaging lens and the like, therefore, image information of the resolution corresponding to the number of the photoelectric converting elements can be read. Since an optical system is not required, the scanner can be thinned as compared with a usual scanner, and, for example, even a middle portion of a thick book which is hardly scanned can be easily scanned by inserting the imaging device 100Y to the portion in such a manner that a bookmark is inserted into the book. When the distance between the photoelectric converting layer 4Y and the object is set to about one half to twice the arrangement pitch of the pixel electrode 3Y, it is possible to obtain a satisfactory scan result without disposing an optical system.

In the imaging device 100Y of the embodiment, light is emitted to the object from the same position as the photoelectric converting element, and hence the imaging accuracy can be improved as compared with a conventional device in which the position of a photoelectric converting element is different from that of a light emitting element.

The imaging device 100Y of the embodiment can be produced by a simple process in which a plurality of photoelectric converting elements are formed above the substrate 1Y, and a light emitting element is formed above the photoelectric converting elements. Therefore, the production can be easily performed as compared with a conventional configuration where photoelectric converting elements and light emitting elements are formed above a substrate while being laterally arranged.

In the imaging device 100Y of the embodiment, each component can be made of a flexible material. Therefore, portions to be imaged are not restricted, and various portions can be scanned.

In the configuration example of FIG. 15, the photoelectric converting layer 4Y and the opposing electrode 5Y are configured into a single-layer structure which is common to the plurality of photoelectric converting elements. Alternatively, these components may be configured for each of the photoelectric converting elements. In the case where these components are configured so as to be commoned as shown in FIG. 15, it is not required to perform a patterning process using the photolithography method on the components other than the pixel electrode 3Y, and hence the imaging device can be easily produced even in the case where an organic material is used in the light emitting layer 8Y and the photoelectric converting layer 4Y.

In the above description, the ammeter 12Y is connected to the pixel electrode 3Y, and a signal is detected by the ammeter 12Y. Alternatively, the substrate 1Y may be formed by a silicon substrate, and a reading unit for reading a signal corresponding to charges captured in the pixel electrode 3Y, such as a charge accumulating unit, a CCD, or a CMOS circuit may be disposed in the silicon substrate, so that the reading unit outputs the signal to the outside.

In the above description, the example in which the plural photoelectric converting elements are disposed above the substrate 1Y has been described. Alternatively, the substrate 1Y may be formed by, for example, a n-type silicon substrate, and configured so that a p-well layer is formed in the n-type silicon substrate, a plurality of photodiodes are formed in the p-well layer, and the light emitting element 16Y is formed on the p-well layer via an insulating layer. According to the configuration, the thickness of the imaging device 100Y can be further reduced, and the production technique of a CCD or CMOS image sensor can be used without modification.

As shown in FIG. 15, during imaging of the object, LIGHT (2) generated in the light emitting layer 8Y is incident on the photoelectric converting layer 4Y in addition to the reflected light from the object. Therefore, the signal obtained from the imaging device 100Y uniformly contains also a signal corresponding to LIGHT (2), as a background signal. The background signal is a DC signal, and hence can be easily removed by interposing a capacitor. Hereinafter, a configuration example of a scanner having a function of removing a background signal will be described.

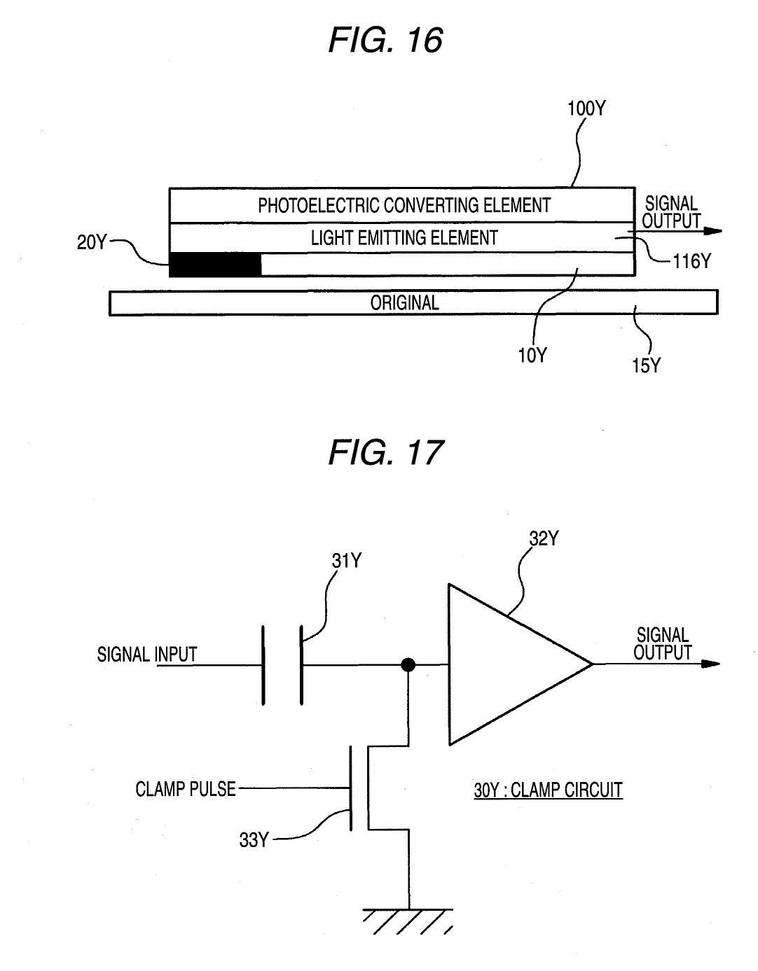

In the imaging device 100Y, a member (for example, tungsten) is disposed above the light emitting element 16Y and at a position where the member overlaps with a part of the plurality of photoelectric converting elements (for example, photoelectric converting elements of one line in an end portion). The member has a light blocking function of preventing light reflected from the object from being incident on the part of the photoelectric converting elements, and an absorbing function of absorbing LIGHT (1) which is emitted toward the side opposite to the side of the photoelectric converting elements among the light emitted from the light emitting layer 8. As shown in FIG. 16, in the protective layer 10Y, for example, only a portion 20Y which overlaps with the part of the photoelectric converting elements is made of a black material.

According to the configuration, only LIGHT (2) which is generated from the light emitting layer 8Y, and which is emitted toward the photoelectric converting elements is incident on the part of the photoelectric converting elements. When a signal obtained from the part of the photoelectric converting elements is detected, therefore, it is possible to obtain a background signal.

FIG. 17 is a diagram showing an example of a clamp circuit which is mounted in the scanner in the embodiment, and which is a circuit for removing a background signal.

The clamp circuit 30Y shown in FIG. 17 includes a capacitor 31Y, an operational amplifier 32Y, and a transistor 33Y.

The imaging signal from the imaging device 100Y is input to one terminal of the capacitor 31Y and an input of the operational amplifier 32Y is connected to the other terminal of the capacitor 31Y.

In the transistor 33Y, the source is grounded, and the drain is connected to the input of the operational amplifier 32Y. A clamp pulse is applied to the gate of the transistor 33Y. The on/off operation of the transistor 33Y is controlled by the clamp pulse.

Next, the operation of the clamp circuit 30Y will be described.

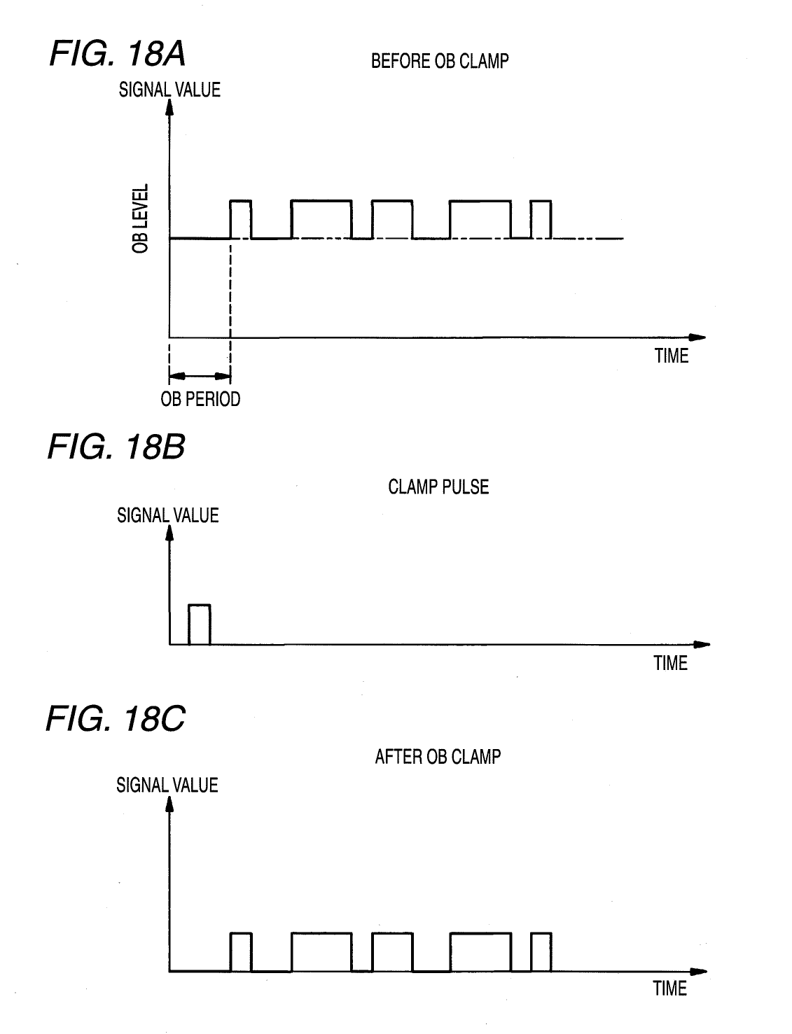

FIGS. 18A, 18B and 18C are views illustrating the operation of the clamp circuit 30Y. FIG. 18A is a view showing the imaging signal supplied from the imaging device 100Y, FIG. 18B is a view showing the waveform of the clamp pulse, and FIG. 18C is a view showing an output signal of the clamp circuit 30Y.

As shown in FIG. 18A, the imaging device 100Y outputs signals from the photoelectric converting elements which overlap with the member (hereinafter, such signals are referred to as OB signal) during an OB period, and then sequentially output signals from the photoelectric converting elements which do not overlap with the member (hereinafter, such signals are referred to as an effective signal). As shown in FIG. 18B, the clamp pulse becomes high during the OB period, so that the clamping operation is performed and the effective signal is converted to a signal with reference to the OB signal. Thereafter, the operational amplifier 32Y of the clamp circuit 30Y outputs a signal in which the background signal is removed as shown in FIG. 18C.

As described above, the member having the light blocking function and the absorbing function is disposed on the light emitting element 16Y of the imaging device 100Y, and the effective signal is handled with reference to the signals obtained from the photoelectric converting elements which overlap with the member, whereby the background signal can be removed and correct imaging can be performed.

In place of the member having the light blocking function and the absorbing function, a white plate or the like having only the light blocking function may be disposed on the light emitting element 16Y, and characteristic degradation of the light emitting layer 8Y and the photoelectric converting layer 4Y may be detected by using the signals from the photoelectric converting elements which overlap with the white plate.

### Second Embodiment

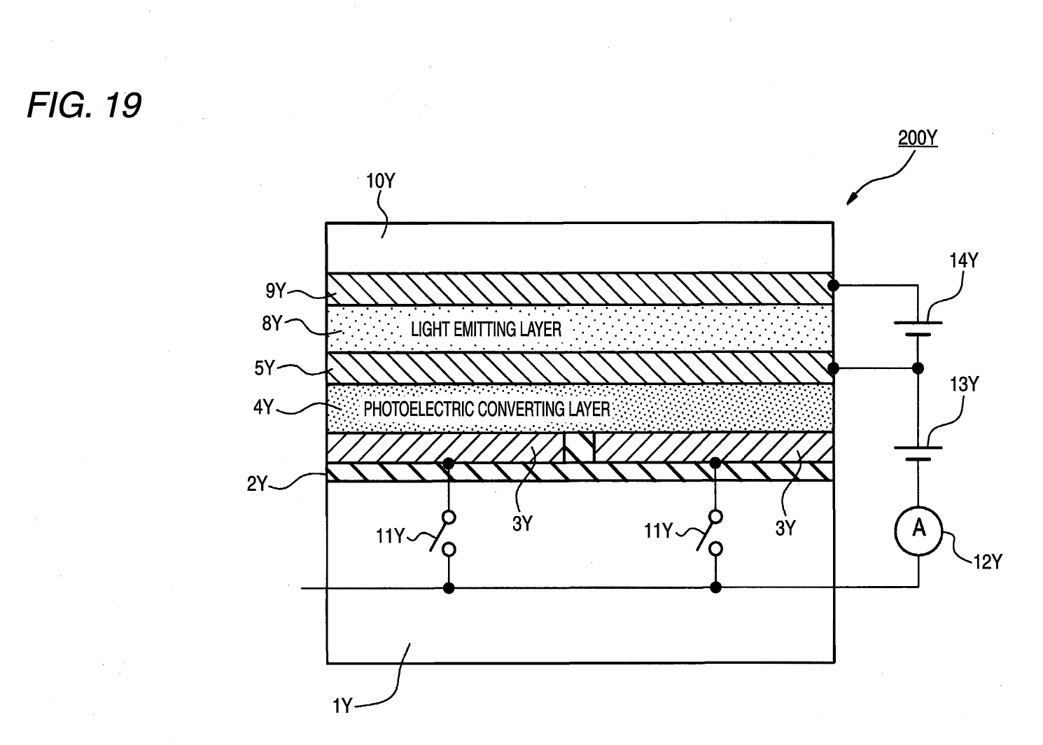

FIG. 19 is a partial sectional diagram schematically showing the configuration of an imaging device of a second embodiment of the third aspect of the invention.

In FIG. 19, components which are similar in configuration to those of FIG. 15 are denoted by the same reference numerals.

The imaging device 200Y shown in FIG. 19 has a configuration where the opposing electrode 5Y of the imaging device 100Y shown in FIG. 15 functions also as the transparent electrode 7Y so as to omit the light emitting electrode 7Y and the insulating layer 6Y. According to the configuration, the number of wirings from the power supplies 13Y, 14Y, the thickness of the imaging device 200Y, and the loss of light incident on the photoelectric converting layer 4Y can be suppressed.

### Third Embodiment

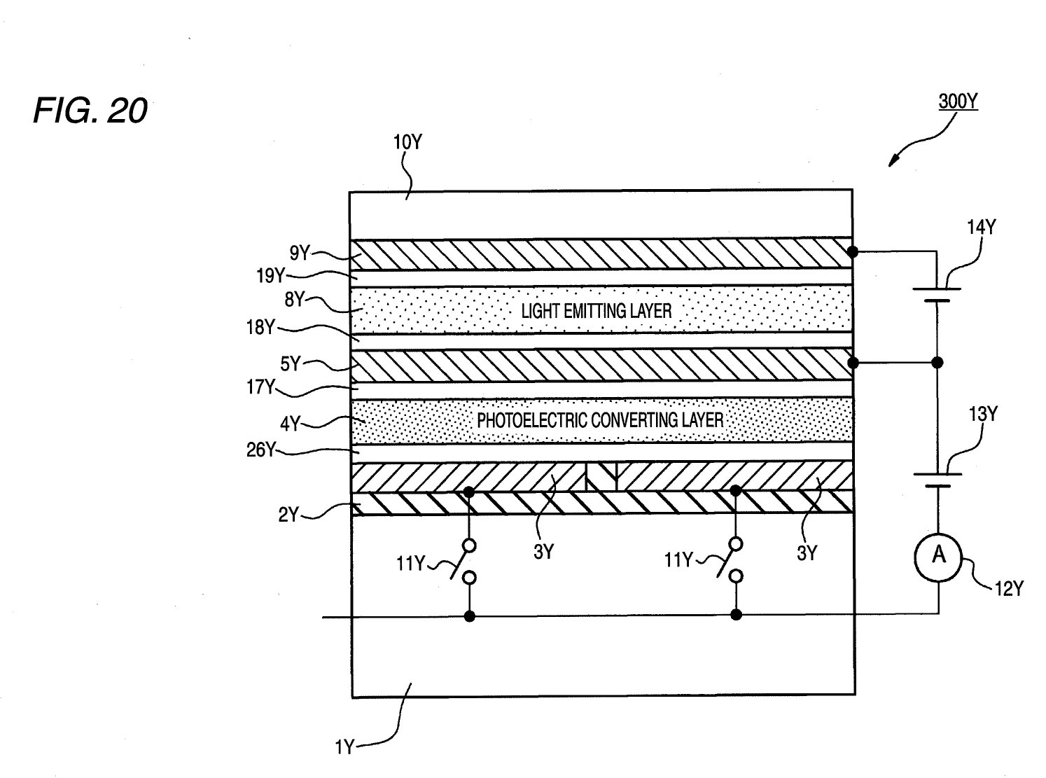

FIG. 20 is a partial sectional diagram schematically showing the configuration of an imaging device of a third embodiment of the third aspect of the invention.

In FIG. 20, components which are similar in configuration to those of FIG. 19 are denoted by the same reference numerals.

The imaging device 300Y shown in FIG. 20 has a configuration where an electron blocking layer 26Y is disposed between the functional layer 3Y of the imaging device 200Y shown in FIG. 19 and the photoelectric converting layer 4Y, a hole blocking layer 17Y is disposed between the photoelectric converting layer 4Y and the opposing electrode 5Y, an electron transporting layer 18Y is disposed between the opposing electrode 5Y and the light emitting layer 8Y, and a hole transporting layer 19Y is disposed between the light emitting layer 8Y and the transparent electrode 9Y.

According to the configuration, injection of holes from the opposing electrode 5Y to the photoelectric converting layer 4Y, and that of electrons from the pixel electrode 3Y to the photoelectric converting layer 4Y can be suppressed, and the dark current can be reduced. Furthermore, movement of electrons from the opposing electrode 5Y to the light emitting layer 8Y, and that of holes from the transparent electrode 9Y to the light emitting layer 8Y are promoted, and hence the emission intensity of the light emitting layer 8Y can be enhanced.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. A light emitting/receiving element having a light emitting function, and a photoelectric converting function of converting received light to charges, wherein said element comprises:
a substrate;
an organic layer which is provided above said substrate;
a forward bias power supply which applies a bias voltage between both ends of said organic layer so as to inject charges from an outside into said organic layer;
a reverse bias power supply which applies a bias voltage, which is opposite in polarity to the bias voltage applied by said forward bias power supply, between the both ends of said organic layer so as to extract charges generated in said organic layer to the outside; and
a current detecting unit which detects a current corresponding to charges generated in said organic layer when the bias voltage is applied by said reverse bias power supply, and
said organic layer comprises an organic material which, when the bias voltage is applied by said forward bias power supply, has the light emitting function, and which, when the bias voltage is applied by said reverse bias power supply, has the photoelectric converting function.

2. The light emitting/receiving element according to claim 1, wherein said element further comprises:
a first electrode which is provided between said substrate and said organic layer;
a second electrode which is provided at a position opposed to said first electrode across said organic layer; and
a switching unit which is switchable between a state where said forward bias power supply is connected between said first and second electrodes, and a state where said reverse bias power supply is connected between said first and second electrodes.

3. The light emitting/receiving element according to claim 2, wherein one of said first and second electrodes is a transparent electrode.

4. The light emitting/receiving element according to claim 2, wherein a plurality of said first electrodes, said organic layers and said second electrodes are two-dimensionally arranged.

5. The light emitting/receiving element according to claim 4, wherein either of said plurality of first electrodes and said plurality of second electrodes are configured as a single commoned electrode, and said plurality of organic layers are configured as a single commoned layer.

6. The light emitting/receiving element according to claim 1, wherein said element further comprises:
first and second electrodes which are provided while being juxtaposed in parallel to said substrate, between said substrate and said organic layer; and
a common electrode which is provided at a position opposed to said second and first electrodes across said organic layer, and which is common to said first and second electrodes,
said forward bias power supply is connected between said first electrode and said common electrode,
said reverse bias power supply is connected between said second electrode and said common electrode, and
said current detecting unit detects a current which flows between said second electrode and said reverse bias power supply, or between said common electrode and said reverse bias power supply.

7. The light emitting/receiving element according to claim 6, wherein said common electrode and one of said first and second electrodes are transparent electrodes.

8. The light emitting/receiving element according to claim 7, wherein a plurality of said first electrode and said second electrode are two-dimensionally arranged.

9. The light emitting/receiving element according to claim 1, wherein said forward bias power supply is a voltage variable power supply which can change a supply voltage.

10. An imaging apparatus having a photoelectric converting function of converting light from an object to charges, and an illuminating function of illuminating the object, wherein said apparatus comprises:
a substrate;
light receiving elements and light emitting elements which are provided above said substrate,
each of said light receiving elements comprising an organic layer which is provided above said substrate, and a pair of electrodes which sandwich said organic layer,
each of said light emitting elements comprising an organic layer which is provided above said substrate, and a pair of electrodes which sandwich said organic layer;
a forward bias power supply which is connected between said pair of electrodes of each of said light emitting elements, and which applies a bias voltage between said pair of electrodes so as to inject charges into said organic layer of said light emitting element;
a reverse bias power supply which is connected between said pair of electrodes of each of said light receiving elements, and which applies a bias voltage, which is opposite in polarity to the bias voltage applied by said forward bias power supply, between said pair of electrodes so as to extract charges generated in said organic layer of said light receiving element to an outside; and
a current detecting unit which detects a signal current corresponding to charges generated in said organic layer of said light receiving element when the bias voltage is applied by said reverse bias power supply,
in said pairs of electrodes included in said light receiving element and said light emitting element, electrodes which are closer to the object are transparent electrodes, and
said organic layer of said light receiving element and said organic layer of said light emitting element are layers which, when the bias voltage is applied by said forward bias power supply, have a light emitting function, which, when the bias voltage is applied by said reverse bias power supply, have the photoelectric converting function, and in which an emission wavelength when the bias voltage is applied by said forward bias power supply overlaps with a reception wavelength when the bias voltage is applied by said reverse bias power supply, and made of a same material.

11. The imaging apparatus according to claim 10, wherein
said organic layer has a two-layer structure of first and second organic layers which are sequentially placed with starting from a side of an electrode that is one of said pair of electrodes, and that is remoter from the object,
an emission wavelength range of said second organic layer when the bias voltage is applied by said forward bias power supply overlaps with an emission wavelength range of said first organic layer when the bias voltage is applied by said reverse bias power supply, and
the emission wavelength range of said first organic layer when the bias voltage is applied by said reverse bias power supply overlaps with a transmission wavelength range of said second organic layer when the bias voltage is applied by said reverse bias power supply.

12. The imaging apparatus according to claim 11, wherein said first organic layer comprises quinacridone, and said second organic layer comprises tris (8-hydroxyquinoline) aluminum.

13. The imaging apparatus according to claim 10, wherein said apparatus further comprises:
a first functional layer which is provided between one of said pair of electrodes and said organic layer, which, when the bias voltage is applied by said forward bias power supply, functions as a hole transporting layer that transports holes injected from said one electrode to said organic layer, and which, when the bias voltage is applied by said reverse bias power supply, functions as an electron blocking layer that blocks electrons from said one electrode from being moved to said organic layer; and
a second functional layer which is provided between another one of said pair of electrodes and said organic layer, which, when the bias voltage is applied by said forward bias power supply, functions as an electron transporting layer that transports electrons injected from said other electrode to said organic layer, and which, when the bias voltage is applied by said reverse bias power supply, functions as a hole blocking layer that blocks holes from said other electrode from being moved to said organic layer.

14. The imaging apparatus according to claim 11, wherein:
said second organic layer functions as a first functional layer which, when the bias voltage is applied by said forward bias power supply, functions as an electron transporting layer that transports electrons injected from said one electrode to said organic layer, and which, when the bias voltage is applied by said reverse bias power supply, functions as a hole blocking layer that blocks holes from said one electrode from being moved to said organic layer, and said apparatus further comprises a second functional layer which is provided between another one of said pair of electrodes that is remoter from the object, and said first organic layer, which, when the bias voltage is applied by said forward bias power supply, functions as a hole transporting layer that transports holes injected from said other electrode to said organic layer, and which, when the bias voltage is applied by said reverse bias power supply, functions as an electron blocking layer that blocks electrons from said other electrode from being moved to said organic layer.

15. The imaging apparatus according to claim 10, wherein
an electrode which is one of said pair of electrodes of said light emitting element, and which is remoter from the object is transparent,
an electrode which is one of said pair of electrodes of said light receiving element, and which is remoter from the object is opaque, and
said apparatus further comprises a lighting controlling unit which, after an exposure period of said light receiving element is ended, applies a bias voltage according to a signal corresponding to charges that are generated in said organic layer during the exposure period, between said pair of electrodes of said light emitting element adjacent to said light receiving element.

16. The imaging apparatus according to claim 10, wherein a plurality of said light receiving elements and said light emitting elements are two-dimensionally arranged.

17. The imaging apparatus according to claim 10, wherein
said organic layer of said light receiving element and said organic layer of said light emitting element are configured as a single commoned layer, and
an electrode which is one of said pair of electrodes of said light emitting element, and which is closer to the object, and an electrode which is one of said pair of electrodes of said light receiving element, and which is closer to the object are configured as a single commoned electrode.

18. An imaging device comprising:
a substrate;
a plurality of photoelectric converting elements which are provided above said substrate; and
a light emitting element which is provided above said plurality of photoelectric converting elements, and which comprises a light emitting layer in which an emission wavelength range is different from an absorption wavelength range.

19. The imaging device according to claim 18, wherein
said light emitting element comprises: a first transparent electrode which is provided between said plurality of photoelectric converting elements and said light emitting layer; and a second transparent electrode which is opposed to said first transparent electrode across said light emitting layer, and
said first and second transparent electrodes are electrodes which allow at least light of the emission wavelength range of said light emitting layer to pass through said electrodes.

20. The imaging device according to claim 18, wherein
each of said photoelectric converting elements comprises: a first electrode which is provided above said substrate; a second electrode which is provided above said first electrode, and which allows at least light of the emission wavelength range of said light emitting element to pass through said electrode; and a photoelectric converting layer which is provided between said first and second electrodes, and
an absorption wavelength range of said photoelectric converting layer overlaps with the emission wavelength range of said light emitting layer.

21. The imaging device according to claim 20, wherein said photoelectric converting layer comprises an organic material and said light emitting layer comprises an organic material.

22. The imaging device according to claim 21, wherein said photoelectric converting layer comprises quinacridone, and said light emitting layer is comprises tris(8-hydroxyquinoline) aluminum.

23. The imaging device according to claim 20, wherein said second electrode and said photoelectric converting layer are configured as a single-layer structure which is common to said plurality of photoelectric converting elements.

24. The imaging device according to claim 23, wherein said second electrode functions also as said first transparent electrode which is provided between said photoelectric converting element and said light emitting layer.

25. The imaging device according to claim 18, wherein said photoelectric converting elements are two-dimensionally arranged above said substrate.

26. The imaging device according to claim 18, wherein said device further comprises a member which is provided above said light emitting element and at a position where said member overlaps with a part of said plurality of photoelectric converting elements, and which has a light blocking function of preventing light reflected from the object from being incident on said part of said photoelectric converting elements, and an absorbing function of absorbing light that is emitted toward a side opposite to a side of said photoelectric converting elements among the light emitted from said light emitting layer.

27. An imaging apparatus including:
the imaging device according to claim 26; and
a signal processing unit for performing a signal process of removing a signal which is included in a signal obtained from photoelectric converting elements other than said part of photoelectric converting elements in accordance with light reflected from the object, and which correspond to light emitted from said light emitting layer toward the side of said photoelectric converting elements, by using a signal obtained from said part of photoelectric converting elements.
